(19) United States
(12) Patent Application Publication
(10) Pub. No.: US 2002/0005909 A1
(43) Pub. Date: Jan. 17, 2002

(54) Image processing apparatus, image processing method, digital camera, and program

(76) Inventor: Junichi Sato, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/892,504

(22) Filed: Jun. 28, 2001

(30) Foreign Application Priority Data
Jun. 28, 2000 (JP) 2000-195100
May 17, 2001 (JP) 2001-148145

(51) Int. Cl. H04N 5/14; H04N 9/64

(52) U.S. Cl. 348/559; 348/576

(57) ABSTRACT

An image processing apparatus comprises display means for displaying a moving image on the basis of input image data; designation means for designating a partial region in a display screen of the display means; and encoding means for encoding the image data. The display means displays a still image of the moving image during designation by the designation means. The encoding means encodes the image data with an image included in the region designated by the designation means of the moving image displayed by the display means being decodable to have higher image quality than an image of a non-designated region.

### FIELD OF THE INVENTION

The present invention relates to the field of an image processing for, e.g., encoding a sensed or reproduced image.

### BACKGROUND OF THE INVENTION

A conventional image processing apparatus will be explained below taking a video camera as an example.

FIG. 28 is a block diagram showing the arrangement of a conventional video camera.

A zoom lens 101 enlarges/reduces an image, and a focus lens 102 focuses an image. An iris 103 adjusts the amount of incoming light. A CCD 104 photoelectrically converts an image, and outputs an image signal. A CDS/AGC circuit 105 samples the output from the CCD 104, and adjusts a gain to a predetermined value. An A/D conversion circuit 107 converts an analog signal into a digital signal, and outputs digital image data. A camera signal processing circuit 108 adjusts a sensed image. A buffer memory 109 temporarily stores image data.

An iris motor 113 adjusts the aperture of the iris 103. An iris motor driver 114 controls the iris motor 113. An iris encoder 112 detects the aperture of the iris 103. A focus motor 115 moves the focus lens 102. A focus motor driver 116 controls the focus motor 115. A zoom motor 117 moves the zoom lens 101. A zoom motor driver 118 controls the zoom motor 117. A zoom encoder 119 detects the position of the zoom lens. A cam table 127 is used to obtain an in-focus curve corresponding to the zoom value.

A system controller 120 controls the entire apparatus. A compression circuit 110 compresses image data. A recording circuit 111 records the compressed image data on a magnetic recording medium, semiconductor memory, or the like. A D/A conversion circuit 123 converts a digital signal into an analog signal. A monitor 124 is a display such as a liquid crystal display (LCD) or the like for displaying a sensed image. A trigger button 128 is used to instruct the recording circuit 111 to start/stop recording of image data. A mode select dial 129 is used to select switching between still and moving images, reproduction of an image, and power OFF.

In the conventional video camera with the aforementioned arrangement, light reflected by an object is zoomed by the zoom lens 101, is focused by the focus lens 102, undergoes light amount adjustment via the iris 103, and forms an image on the image sensing surface of the CCD 104. The image on the image sensing surface is photoelectrically converted by the CCD 104, is sampled by the CDS/AGC circuit 105 to adjust its gain, and is converted into a digital signal by the A/D conversion circuit 107. The image quality of image data is adjusted by the camera signal processing circuit 108, and the adjusted image data is stored in the buffer memory 109.

When a zoom instruction is input via a zoom lever 125, a zoom operation is made in a tele (T) or wide (W) direction. For this purpose, the pressed state of the zoom lever 125 is detected, and the system controller 120 sends a signal to the zoom motor driver 118 in accordance with the detection result, thus moving the zoom lens 101 via the zoom motor 117. At the same time, the system controller 120 acquires in-focus information from the cam table 127, and sends a signal to the focus motor driver 116 on the basis of the acquired in-focus information. By moving the focus lens 102 via the focus motor 115, the zoom operation is attained while maintaining an in-focus state.

The image data stored in the buffer memory 109 is converted into an analog signal by the D/A converter 123, and is displayed on the monitor 124.

On the other hand, the image data stored in the buffer memory 109 is compressed by a high-efficiency coding process in the compression circuit 110, and the compressed image data is stored in the recording circuit 111.

When a moving image mode is selected by the mode select dial 129, an image within the operation period of the trigger button 128 is recorded as a moving image in the recording circuit 111. On the other hand, when a still image mode is selected by the mode select dial 129, an image at the time of depression of the trigger button 129 is recorded in the recording circuit 111.

The high-efficiency coding process based on DCT (discrete cosine transformation) used in such conventional digital video camera will be described below using the block diagram in FIG. 29.

A block processing circuit 131 forms DCT blocks. A shuffling circuit 132 rearranges image blocks. A DCT processing circuit 133 computes orthogonal transforms. A quantization processing circuit 134 quantizes image data. An encoding circuit 135 executes Huffman coding or the like. A deshuffling circuit 136 obtains rearranged image data. A coefficient setting circuit 137 determines quantization coefficients.

A case will be explained below wherein the aforementioned coding process is applied to the conventional video camera. Image data output from the buffer memory 109 is broken up by the block processing circuit 131 into blocks each consisting of 8×8 pixels. Then, a total of six DCT blocks, i.e., four luminance signals and one each color difference signals, form one macroblock. The shuffling circuit 132 shuffles in units of macroblocks to equalize information amounts. After that, the DCT processing circuit 133 computes orthogonal transforms. Frequency coefficient data output from the DCT processing circuit 133 are input to the quantization processing circuit 134. The quantization processing circuit 134 divides a set of data coefficients for respective frequency components by an appropriate numerical value generated by the coefficient setting circuit 137. Furthermore, the encoding circuit 135 encodes the coefficients to convert them into variable-length codes, and the deshuffling circuit 136 restores an original image arrangement and outputs it to the recording circuit 111. In this way, the data size can be compressed to about ⅕.

However, since the conventional image processing apparatus such as a video camera or the like entirely equalizes and compresses image data, if the compressed image data also undergoes high-efficiency coding, the overall image quality impairs uniformly. Conversely, to obtain high image quality, the compression ratio lowers entirely, and the data size cannot be reduced. That is, only a single process can be selected for the entire image.

### SUMMARY OF THE INVENTION

It is a principal object of the present invention to maintain image quality within a required range of an image, and to reduce the data size as a whole.

According to the present invention, there is provided an image processing apparatus comprising:

display means for displaying a moving image on the basis of input image data;

designation means for designating a partial region in a display screen of the display means; and

encoding means for encoding the image data,

wherein the display means displays a still image of the moving image during designation by the designation means, and

the encoding means encodes the image data with an image included in the region designated by the designation means of the moving image displayed by the display means being decodable to have higher image quality than an image of a non-designated region.

According to the present invention, there is also provided an image processing apparatus comprising:

display means for displaying a moving image on the basis of input image data;

designation means for designating an object included in the moving image displayed by the display means; and

encoding means for encoding the image data,

wherein the display means displays a still image of the moving image during designation by the designation means, and

the encoding means encodes the image data with an image indicating the object designated by the designation means of the moving image displayed by the display means being decodable to have higher image quality than an image of a non-designated portion.

According to the present invention, there is also provided an image processing apparatus comprising:

display means for displaying a moving image on the basis of input image data;

designation means for designating a partial region in a display screen of the display means; and

encoding means for encoding the image data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image included in the region designated by the designation means of the moving image displayed by the display means by a predetermined number of bits.

According to the present invention, there is also provided an image processing apparatus comprising:

display means for displaying a moving image on the basis of input image data;

designation means for designating an object included in the moving image displayed by the display means; and

encoding means for encoding the image data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image indicating the object designated by the designation means of the moving image displayed by the display means by a predetermined number of bits.

According to the present invention, there is also provided a digital camera comprising:

image sensing means for generating image data by sensing an image;

display means for displaying a moving image on the basis of the image data;

designation means for designating a partial region in a display screen of the display means;

encoding means for encoding the image data; and

means for saving the encoded data,

wherein the display means displays a still image of the moving image during designation by the designation means, and

the encoding means encodes the image data with an image included in the region designated by the designation means of the moving image displayed by the display means being decodable to have higher image quality than an image of a non-designated region.

According to the present invention, there is also provided a digital camera comprising:

image sensing means for generating image data by sensing an image;

display means for displaying a moving image on the basis of the image data;

designation means for designating an object included in the moving image displayed by the display means;

encoding means for encoding the image data; and

means for saving the encoded data,

wherein the display means displays a still image of the moving image during designation by the designation means, and

the encoding means encodes the image data with an image indicating the object designated by the designation means of the moving image displayed by the display means being decodable to have higher image quality than an image of a non-designated portion.

According to the present invention, there is also provided a digital camera comprising:

image sensing means for generating image data by sensing an image;

display means for displaying a moving image on the basis of the image data;

designation means for designating a partial region in a display screen of the display means;

encoding means for encoding the image data; and

means for saving the encoded data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image included in the region designated by the designation means of the moving image displayed by the display means by a predetermined number of bits.

According to the present invention, there is also provided a digital camera comprising:

image sensing means for generating image data by sensing an image;

display means for displaying a moving image on the basis of the image data;

designation means for designating an object included in the moving image displayed by the display means;

encoding means for encoding the image data; and

means for saving the encoded data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image indicating the object designated by the designation means of the moving image displayed by the display means by a predetermined number of bits.

According to the present invention, there is also provided an image processing method comprising:

the display step of displaying a moving image on the basis of input image data;

the designation step of designating a partial region in a display screen in the display step; and

the encoding step of encoding the image data,

wherein the display step includes the step of displaying a still image of the moving image during designation in the designation step, and

the encoding step includes the step of encoding the image data with an image included in the region designated in the designation step of the moving image displayed in the display step being decodable to have higher image quality than an image of a non-designated region.

According to the present invention, there is also provided an image processing method comprising:

the display step of displaying a moving image on the basis of input image data;

the designation step of designating an object included in the moving image displayed in the display step; and

the encoding step of encoding the image data,

wherein the display step includes the step of displaying a still image of the moving image during designation in the designation step, and

the encoding step includes the step of encoding the image data with an image indicating the object designated in the designation step of the moving image displayed by the display step being decodable to have higher image quality than an image of a non-designated portion.

According to the present invention, there is also provided an image processing method comprising:

the display step of displaying a moving image on the basis of input image data;

the designation step of designating a partial region in a display screen in the display step; and

the encoding step of encoding the image data,

wherein the display step includes the step of displaying a still image of the moving image during designation in the designation step,

the encoding step comprises:

the step of generating transform coefficients by computing discrete wavelet transforms of the image data;

the step of generating quantization indices by quantizing the transform coefficients; and

the step of generating encoded data by decomposing the quantization indices into bit planes, and executing arithmetic coding for the respective bit planes, and

the encoding step includes the step of shifting up the quantization indices corresponding to an image included in the region designated in the designation step of the moving image displayed by the display step by a predetermined number of bits.

According to the present invention, there is also provided an image processing method comprising:

the display step of displaying a moving image on the basis of input image data;

the designation step of designating an object included in the moving image displayed in the display step; and

the encoding step of encoding the image data,

wherein the display step includes the step of displaying a still image of the moving image during designation in the designation step,

the encoding step comprises:

the step of generating transform coefficients by computing discrete wavelet transforms of the image data;

the step of generating quantization indices by quantizing the transform coefficients; and

the step of generating encoded data by decomposing the quantization indices into bit planes, and executing arithmetic coding for the respective bit planes, and

the encoding step includes the step of shifting up the quantization indices corresponding to an image indicating the object designated in the designation step of the moving image displayed by the display step by a predetermined number of bits.

According to the present invention, there is also provided a program for making a computer function as:

display means for displaying a moving image on the basis of input image data;

designation means for designating a partial region in a display screen of the display means; and

encoding means for encoding the image data,

wherein the display means displays a still image of the moving image during designation by the designation means, and

the encoding means encodes the image data with an image included in the region designated by the designation means of the moving image displayed by the display means being decodable to have higher image quality than an image of a non-designated region.

According to the present invention, there is also provided a program for making a computer function as:

display means for displaying a moving image on the basis of input image data;

designation means for designating an object included in the moving image displayed by the display means; and

encoding means for encoding the image data,

wherein the display means displays a still image of the moving image during designation by the designation means, and

the encoding means encodes the image data with an image indicating the object designated by the designation means of the moving image displayed by the display means being decodable to have higher image quality than an image of a non-designated portion.

According to the present invention, there is also provided a program for making a computer function as:

display means for displaying a moving image on the basis of input image data;

designation means for designating a partial region in a display screen of the display means; and

encoding means for encoding the image data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image included in the region designated by the designation means of the moving image displayed by the display means by a predetermined number of bits.

According to the present invention, there is also provided a program for making a computer function as:

display means for displaying a moving image on the basis of input image data;

designation means for designating an object included in the moving image displayed by the display means; and

encoding means for encoding the image data,

wherein the display means displays a still image of the moving image during designation by the designation means,

the encoding means comprises:

means for generating transform coefficients by computing discrete wavelet transforms of the image data;

means for generating quantization indices by quantizing the transform coefficients; and

means for generating encoded data by decomposing the quantization indices into bit planes, and executing arithmetic coding for the respective bit planes, and

the encoding means shifts up the quantization indices corresponding to an image indicating the object designated by the designation means of the moving image displayed by the display means by a predetermined number of bits.

According to the present invention, there is also provided an image processing apparatus comprising:

display means for displaying a moving image on the basis of input image data;

designation means for designating a partial region in a display screen of the display means;

encoding means for generating encoded data by encoding the image data;

storage means for storing the encoded data; and

decoding means for decoding the encoded data stored in the storage means,

wherein the display means displays a still image of the moving image during designation by the designation means,

the encoding means encodes the image data with an image included in the region designated by the designation means of the moving image displayed by the display means being decodable to have higher image quality than an image of a non-designated region,

the decoding means decodes encoded data at least from the beginning to the end of designation of the region by the designation means of the encoded data stored in the storage means, and

the encoding means re-encodes the decoded image data with an image corresponding to the region of an image that corresponds to the image data decoded by the decoding means being decodable to have higher image quality than an image of the non-designated region.

According to the present invention, there is also provided an image processing apparatus comprising:

display means for displaying a moving image on the basis of input image data;

designation means for designating an object included in the moving image displayed by the display means;

encoding means for generating encoded data by encoding the image data;

storage means for storing the encoded data; and

decoding means for decoding the encoded data stored in the storage means,

wherein the display means displays a still image of the moving image during designation by the designation means,

the encoding means encodes the image data with an image indicating the object designated by the designation means of the moving image displayed by the display means being decodable to have higher image quality than an image of a non-designated portion,

the decoding means decodes encoded data at least from the beginning to the end of designation of the object by the designation means of the encoded data stored in the storage means, and

the encoding means re-encodes the decoded image data with an image corresponding to the object of an image that corresponds to the image data decoded by the decoding means being decodable to have higher image quality than an image of the non-designated region.

According to the present invention, there is also provided an image processing method comprising:

the display step of displaying a moving image on the basis of input image data;

the designation step of designating a partial region in a display screen in the display step;

the encoding step of generating encoded data by encoding the image data;

the storage step of storing the encoded data; and

the decoding step of decoding the encoded data stored in the storage step,

wherein the display step includes the step of displaying a still image of the moving image during designation in the designation step,

the encoding step includes the step of encoding the image data with an image included in the region designated in the designation step of the moving image displayed in the display step being decodable to have higher image quality than an image of a non-designated region,

the decoding step includes the step of decoding encoded data at least from the beginning to the end of designation of the region in the designation step of the encoded data stored in the storage step, and

the encoding step includes the step of re-encoding the decoded image data with an image corresponding to the region of an image that corresponds to the image data decoded in the decoding step being decodable to have higher image quality than an image of the non-designated region.

According to the present invention, there is also provided an image processing method comprising:

the display step of displaying a moving image on the basis of input image data;

the designation step of designating an object included in the moving image displayed in the display step;

the encoding step of generating encoded data by encoding the image data;

the storage step of storing the encoded data; and

the decoding step of decoding the encoded data stored in the storage step,

wherein the display step includes the step of displaying a still image of the moving image during designation in the designation step,

the encoding step includes the step of encoding the image data with an image indicating the object designated in the designation step of the moving image displayed in the display step being decodable to have higher image quality than an image of a non-designated portion,

the decoding step includes the step of decoding encoded data at least from the beginning to the end of designation of the object in the designation step of the encoded data stored in the storage step, and

the encoding step includes the step of re-encoding the decoded image data with an image corresponding to the object of an image that corresponds to the image data decoded in the decoding step being decodable to have higher image quality than an image of the non-designated region.

According to the present invention, there is also provided a program for making a computer function as:

display means for displaying a moving image on the basis of input image data;

designation means for designating a partial region in a display screen of the display means;

encoding means for generating encoded data by encoding the image data; and

storage means for storing the encoded data; and

decoding means for decoding the encoded data stored in the storage means,

wherein the display means displays a still image of the moving image during designation by the designation means,

the encoding means encodes the image data with an image included in the region designated by the designation means of the moving image displayed by the display means being decodable to have higher image quality than an image of a non-designated region,

the decoding means decodes encoded data at least from the beginning to the end of designation of the region by the designation means of the encoded data stored in the storage means, and

the encoding means re-encodes the decoded image data with an image corresponding to the region of an image that corresponds to the image data decoded by the decoding means being decodable to have higher image quality than an image of the non-designated region.

According to the present invention, there is also provided a program for making a computer function as:

display means for displaying a moving image on the basis of input image data;

designation means for designating an object included in the moving image displayed by the display means;

encoding means for generating encoded data by encoding the image data;

storage means for storing the encode data; and

decoding means for decoding the encoded data stored in the storage means,

wherein the display means displays a still image of the moving image during designation by the designation means,

the encoding means encodes the image data with an image indicating the object designated by the designation means of the moving image displayed by the display means being decodable to have higher image quality than an image of a non-designated portion,

the decoding means decodes encoded data at least from the beginning to the end of designation of the object by the designation means of the encoded data stored in the storage means, and

the encoding means re-encodes the decoded image data with an image corresponding to the object of an image that corresponds to the image data decoded by the decoding means being decodable to have higher image quality than an image of the non-designated region.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an image processing apparatus according to an embodiment of the present invention;

FIG. 2 is a block diagram of a discrete wavelet transformer 2;

FIG. 3A is a diagram showing the arrangement of two-dimensional discrete wavelet transformation;

FIG. 3B shows an example (pictorial view) of the two-dimensional discrete wavelet transformation result of an image;

FIG. 4A shows mask information;

FIGS. 4B and 4C show changes in quantization index;

FIGS. 5A and 5B show the operation of an entropy encoder;

FIGS. 6A to 6C show the subband configuration of two-dimensional discrete wavelet transformation of a color image;

FIGS. 7A to 7C show the subband configuration of two-dimensional discrete wavelet transformation of a color image;

FIGS. 8A to 8C show the subband configuration of two-dimensional discrete wavelet transformation of a color image;

FIGS. 9A to 9E show the format of a code sequence;

FIGS. 10A to 10E show the format of a code sequence;

FIG. 11 is a block diagram showing the arrangement of an image decoding apparatus;

FIGS. 12A and 12B show the operation of an entropy decoder 8;

FIG. 13 is a block diagram of an inverse discrete wavelet transformer 10;

FIG. 14A shows the format of a code sequence;

FIG. 14B shows images obtained by decoding the code sequence;

FIG. 15A shows the format of a code sequence;

FIG. 15B shows images obtained by decoding the code sequence;

FIG. 16A is a perspective view showing the outer appearance of a video camera to which the image processing apparatus is applied;

FIG. 16B is an enlarged view of a region designation lever 36;

FIG. 16C is a diagram showing the arrangement of a region designation lever detection circuit 37;

FIG. 17A is a block diagram showing the arrangement of a video camera according to the first embodiment of the present invention;

FIG. 17B shows a display example on a monitor 40;

FIG. 18 is a flow chart showing the process in the video camera shown in FIG. 17A;

FIG. 19 is a block diagram of a compression circuit 21;

FIGS. 20A to 20C show a change in display on the monitor upon region designation operation;

FIG. 21A shows a display on the monitor;

FIG. 21B shows a detected object image;

FIG. 22 is a block diagram showing the arrangement of a video camera according to the second embodiment of the present invention;

FIG. 23 is a flow chart showing the process in the video camera shown in FIG. 22;

FIG. 24 is a block diagram showing the arrangement of a video camera according to the third embodiment of the present invention;

FIG. 25 is a flow chart showing the process in the video camera shown in FIG. 24;

FIG. 26 is a block diagram showing the arrangement of a video camera according to the fourth embodiment of the present invention;

FIG. 27 shows a display example on a monitor 40 of the video camera shown in FIG. 26;

FIG. 28 is a block diagram showing the arrangement of a conventional video camera;

FIG. 29 is a block diagram showing the arrangement of a compression processing device in the conventional video camera;

FIG. 30 is a block diagram showing the arrangement of a video camera according to the fifth embodiment of the present invention;

FIG. 31 is a flow chart showing the process in the video camera shown in FIG. 30; and

FIG. 32 is a flow chart showing the process in the video camera shown in FIG. 30.

### DETAILED DESCRIPTION OF THE PREFERRED EMBODIMENTS

Preferred embodiments of the present invention will now be described in detail in accordance with the accompanying drawings.

<First Embodiment>

A high-efficiency coding process in the present invention will be explained first.

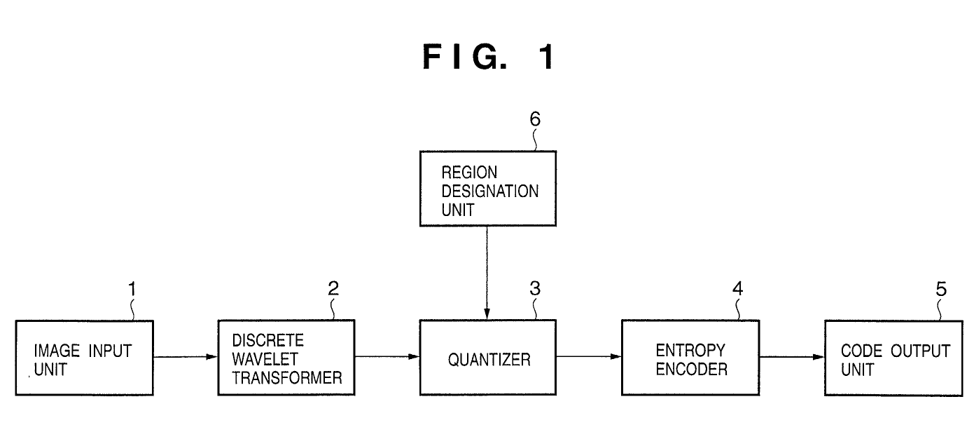

FIG. 1 is a block diagram of an image processing apparatus according to an embodiment of the present invention. Reference numeral 1 denotes an image input unit; 2, a discrete wavelet transformer; 3, a quantizer; 4, an entropy encoder; 5, a code output unit; and 6, a region designation unit.

The image input unit 1 receives pixel signals that form an image to be encoded in the raster scan order, and its output is supplied to the discrete wavelet transformer 2. In the following description, an image signal represents a monochrome multi-valued image.

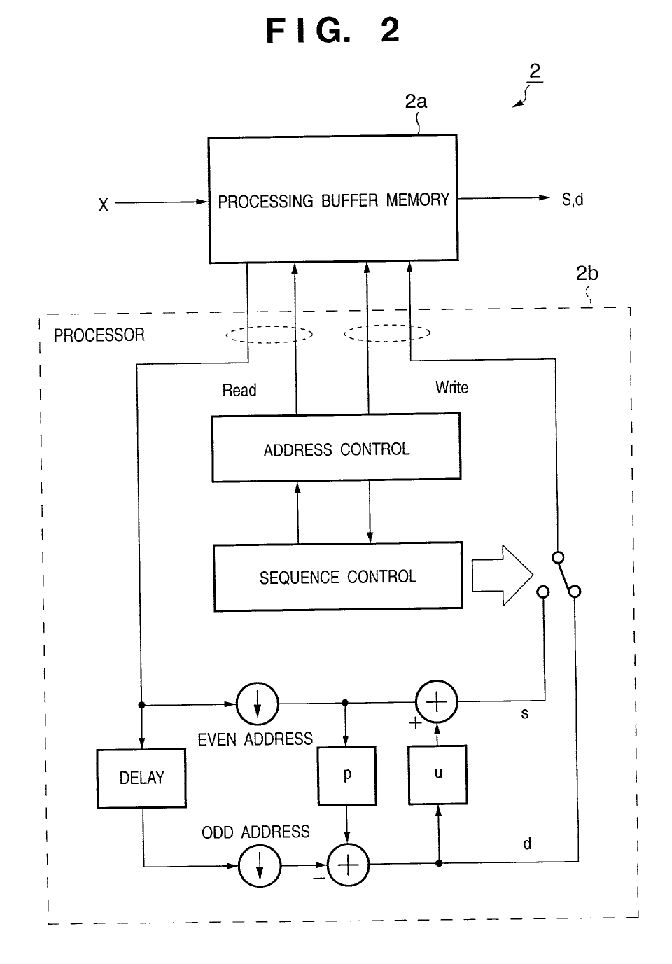

The discrete wavelet transformer 2 executes a two-dimensional wavelet transformation process for the input image signal, and computes and outputs transform coefficients. FIG. 2 is a block diagram showing the basic arrangement of the discrete wavelet transformer 2. An input image signal X is stored in a memory 2a, is sequentially read out by a processor 2b to undergo the discrete wavelet transformation process, and is written in the memory 2a again.

The arrangement of the process in the processor 2b will be explained below. Upon receiving a read instruction from a sequence control circuit in the processor 2b, the image signal X is read by the processor 2b. The image signal X is separated into odd and even address signals by a combination of a delay element and down samplers, and these signals undergo filter processes of two filters p and u. In FIG. 2, s and d represent low- and high-pass coefficients upon decomposing a linear image signal to one level. Also, x(n) represents an image signal to be transformed. Upon issuing a write instruction from the sequence control circuit, low- and high-pass coefficients s and d used to decompose a signal to one level are stored again in the memory 2a.

With the aforementioned process, a linear discrete wavelet transformation process is done for the image signal.

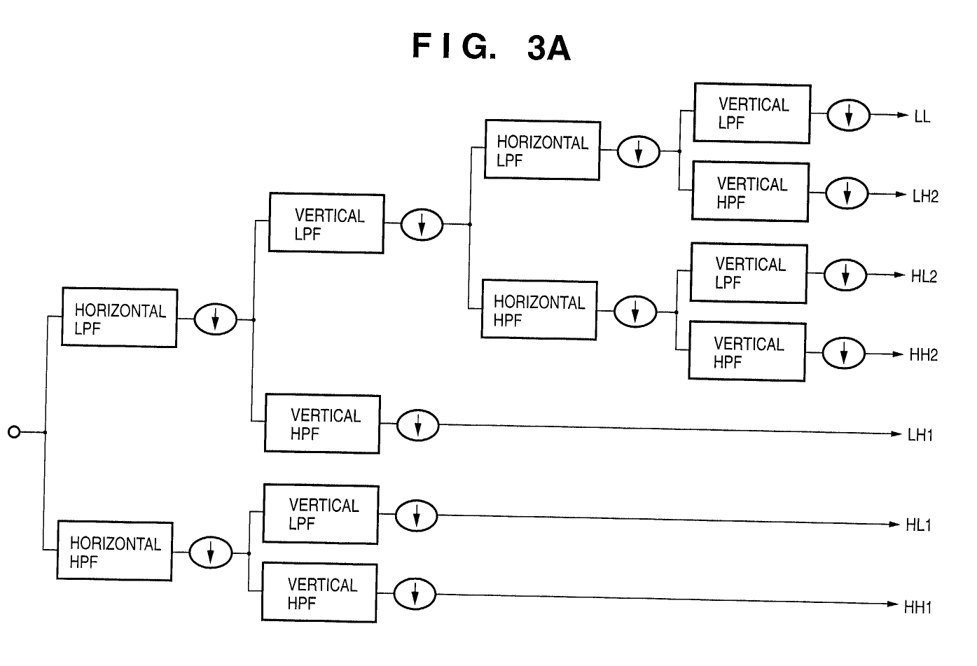

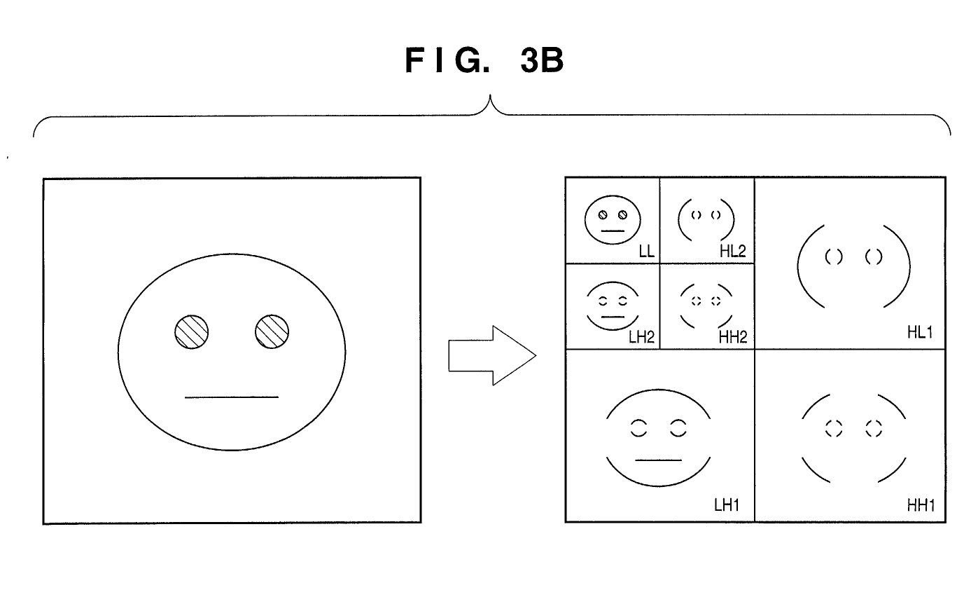

FIG. 3A shows the arrangement of two-dimensional discrete wavelet transformation. In FIG. 3A, two-dimensional discrete wavelet transformation is implemented by sequentially executing linear transformation in the horizontal and vertical directions of an image. An input image signal undergoes a wavelet transformation process in the horizontal direction and is decomposed into low- and high-pass coefficients. After that, data is decimated to be halved by downsizing (downward arrow).

As coefficient components generated as a result of repeating the aforementioned process for components obtained by executing low-pass filtering of the output data in the horizontal and vertical directions, coefficient data with a reduced data size in a low-frequency region as frequency divisions in the horizontal and vertical directions are accumulated.

A horizontal high-frequency and vertical low-frequency region obtained by the first division is represented by LH1, a horizontal low-frequency and vertical high-frequency region by LH1, and a horizontal high-frequency and vertical high-frequency region by HH1. A horizontal low-frequency and vertical low-frequency region undergoes the second division to obtain HL2, LH2, and HH2, and the remaining horizontal low-frequency and vertical low-frequency region is represented by LL. In this way, the image signal is decomposed into coefficient sequences HH1, HL1, LH1, HH2, HL2, LH2, and LL of different frequency bands.

Note that these coefficient sequences will be referred to as subbands hereinafter. The respective subbands are output to the quantizer 3. FIG. 3B shows an example (pictorial view) of the two-dimensional discrete wavelet transformation result of an image. In FIG. 3B, the left image is an original image, and the right image is a transformed image.

Referring back to FIG. 1, the region designation unit 6 designates a region (to be referred to as a designated region or an ROI: region of interest hereinafter) to be decoded to have higher image quality than the surrounding portions in an image to be encoded, and generates mask information indicating coefficients that belong to the designated region upon computing the discrete wavelet transforms of the image to be encoded.

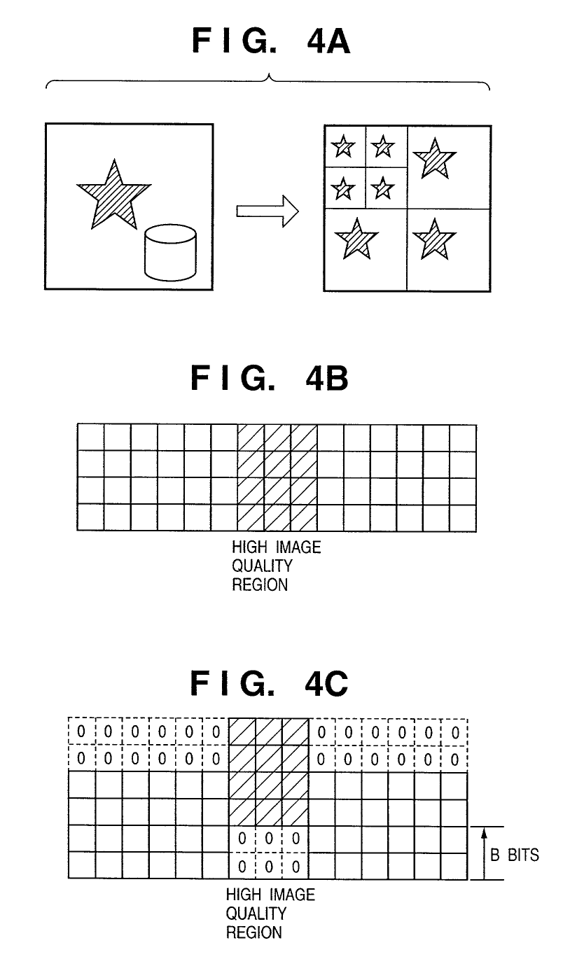

FIG. 4A shows an example upon generating mask information. When a black-painted star-shaped region in the left image in FIG. 4A is designated, the region designation unit 6 computes portions to be included in respective subbands upon computing the discrete wavelet transforms of the image including this designated region. Note that the region indicated by this mask information corresponds to a range including surrounding transform coefficients required for reconstructing an image signal on the boundary of the designated region. The right image in FIG. 4A shows an example of the mask information computed in this way. This example shows mask information obtained when the left image in FIG. 4A undergoes discrete wavelet transformation of two levels. In FIG. 4A, a black-painted star-shaped portion corresponds to the designated region, bits of the mask information in this designated region are set at “1”, and other bits of the mask information are set at “0”. Since the entire mask information has the same format as that of the transform coefficients of two-dimensional discrete wavelet transformation, whether or not a coefficient at a corresponding position belongs to the designated region can be identified by checking the corresponding bit in the mask information. The mask information generated in this manner is output to the quantizer 3.

Furthermore, the region designation unit 6 has parameters for defining the image quality of that designated region. Such parameters may be either numerical values that express a compression ratio to be assigned to the designated region or those indicating image quality, and may be set in advance or input using another input device. The region designation unit 6 computes a bit shift amount (B) for coefficients in the designated region based on the parameters, and outputs it to the quantizer 3 together with the mask.

The quantizer 3 quantizes the input coefficients by a predetermined quantization step, and outputs indices corresponding to the quantized values. The quantizer 3 changes the quantization index on the basis of the mask information and bit shift amount B input from the region designation unit 6. With the aforementioned process, only quantization indices that belong to the spatial region designated by the region designation unit 6 are shifted up (to the MSB side) by B bits.

FIGS. 4B and 4C show changes in quantization index by the shift-up process. FIG. 4B shows quantization indices of given subbands. When the mask value=“1” and the shift-up value B=“2” in the hatched quantization indices, the shifted quantization indices are as shown in FIG. 4C. Note that bits “0” are stuffed in blanks formed as a result of this bit shift process, as shown in FIG. 4C.

The quantization indices changed in this manner are output to the entropy encoder 4.

Note that the mask information in this embodiment is used not only in the shift-up process but also to accurately restore an original image from data obtained after encoding by the entropy encoder 4. However, the present invention is not limited to this. For example, if the shift-up value B is set to be equal to the number of bits (4 bits in FIG. 4C) of each quantization index which is to undergo the bit shift process, a decoder can easily discriminate the ROI and non-ROI regions without receiving any mask information, and can accurately restore an original image.

The entropy encoder 4 decomposes the quantization indices input from the quantizer 3 into bit planes, executes arithmetic coding such as binary arithmetic coding or the like for respective bit planes, and outputs code streams.

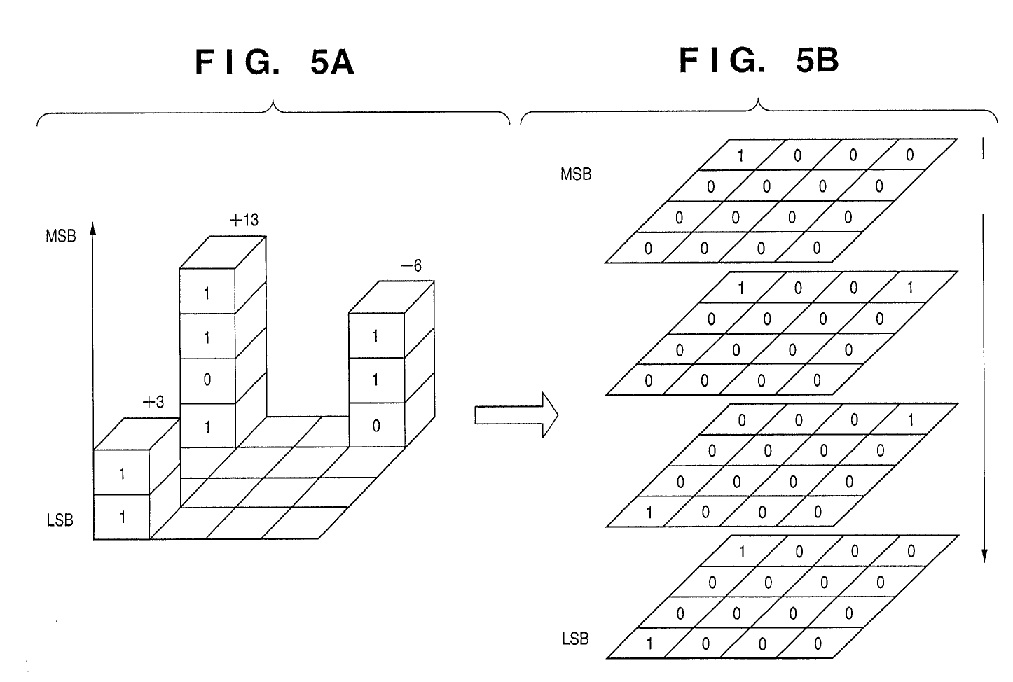

The entropy encoder 4 makes entropy coding (binary arithmetic coding in this embodiment) of bits of the most significant bit plane (indicated by MSB in FIG. 5B) first, and outputs the coding result as a bitstream. Then, the encoder 4 lowers the bit plane by one level, and encodes and outputs bits of each bit plane to the code output unit 5 until the bit plane of interest reaches the least significant bit plane (indicated by LSB in FIG. 5B). Upon scanning bit planes from the MSB to the LSB in entropy coding, when a nonzero bit to be encoded first (most significantly) of a code of each quantization index is detected, 1 bit that indicates the positive/negative sign of that quantization index is encoded by binary arithmetic coding immediately after the nonzero bit. In this way, the positive/negative sign of a nonzero quantization index can be efficiently encoded.

(In case of color process)

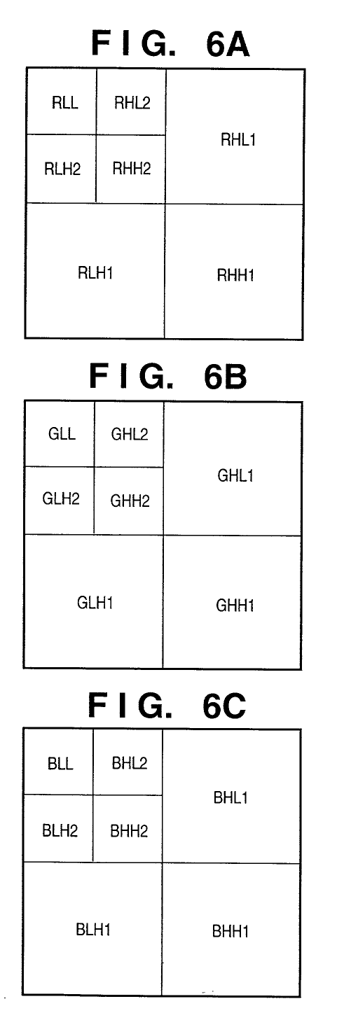

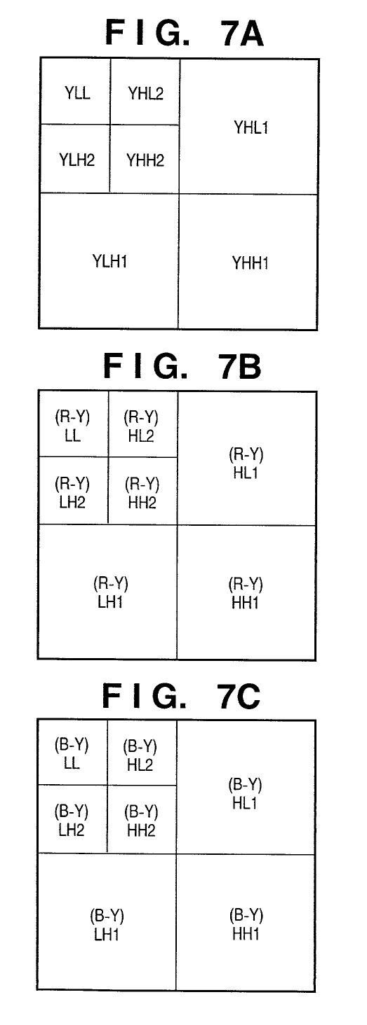

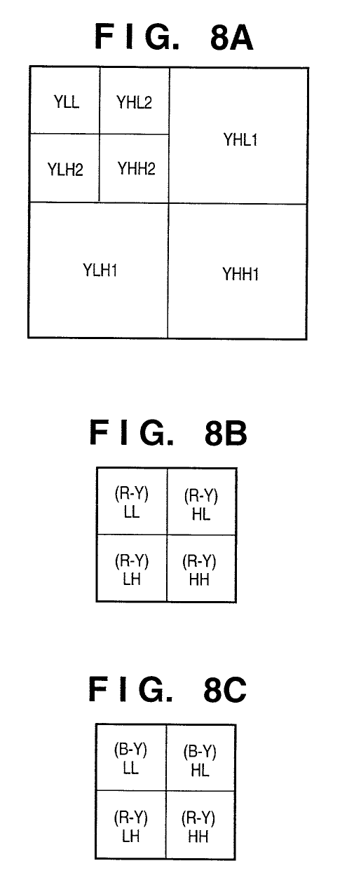

In the above description, a monochrome image has been exemplified. In case of a color image using R, G, and B component signals, the respective component signals can be independently encoded. FIGS. 6A to 6C show subband coefficients of respective signals upon processing R, G, and B component signals. FIGS. 7A to 7C show subband coefficients of respective signals upon processing component signals including a luminance signal and two color difference signals. Note that the information sizes of the luminance signal and color difference signals are set at a ratio of 4:1:1 since human visual characteristics are more sensitive to luminance than color information. FIG. 8A to 8C show subband coefficients upon processing luminance and color difference signals at 4:1:1. (Spatial scalable)

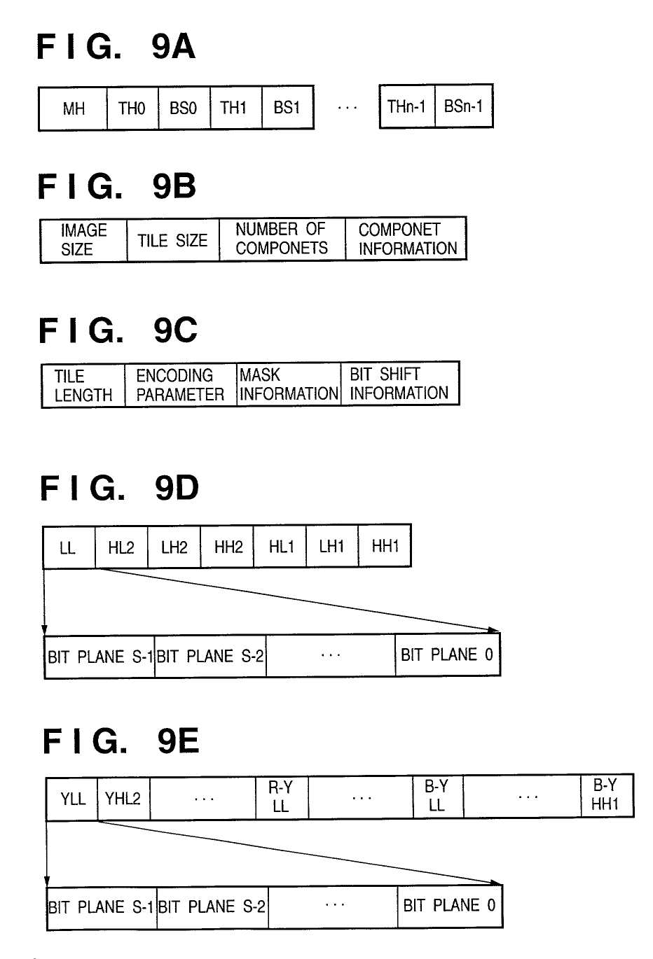

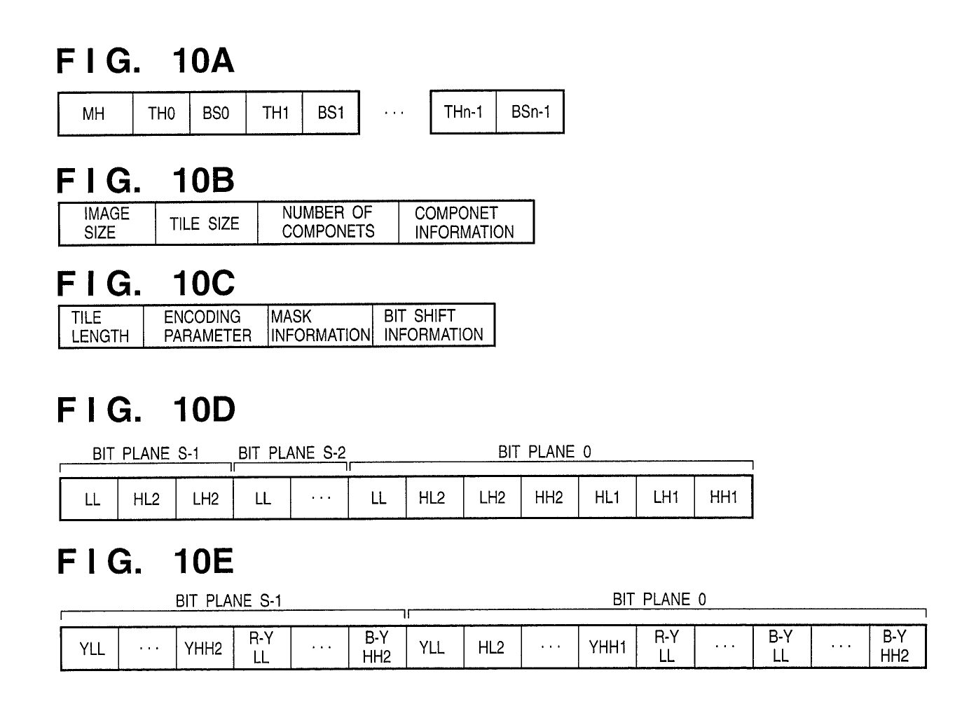

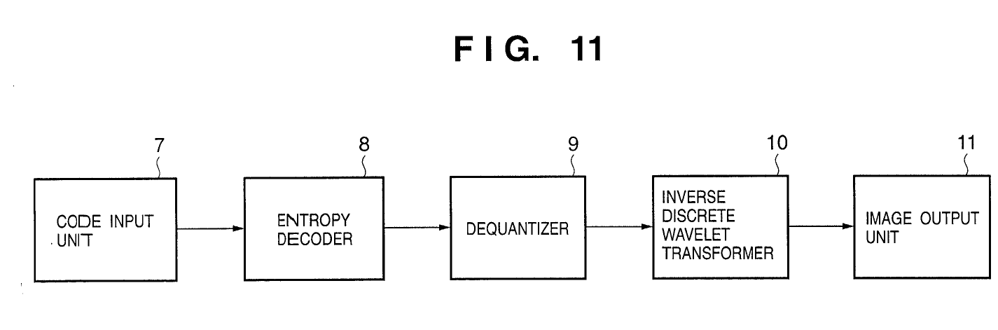

FIGS. 9A to 9E show the format of a code sequence in which bitstreams encoded in this way are arranged in ascending order of resolution of the subbands (spatial scalable) and are hierarchically output.

FIG. 9A shows the overall format of a code sequence, in which MH is a main header; TH, a tile header; and BS, a bitstream. As shown in FIG. 9B, the main header MH is comprised of the size (the numbers of pixels in the horizontal and vertical directions) of an image to be encoded, a size upon breaking up the image into tiles as a plurality of rectangular regions, the number of components indicating the number of color components, the size of each component, and component information indicating bit precision. In this embodiment, since an image is not broken up into tiles, the tile size is equal to the image size. When the image to be encoded is a monochrome multi-valued image, the number of components is “1”; when it is a color multi-valued image made up of R, G, and B component signals or a luminance and two color difference signals, the number of components is “3”.

FIG. 9C shows the format of the tile header TH. The tile header TH consists of a tile length including the bitstream length and header length of the tile of interest, an encoding parameter for the tile of interest, mask information indicating the designated region, and the bit shift amount for coefficients that belong to the designated region. The encoding parameter includes a discrete wavelet transform level, filter type, and the like.

FIG. 9D shows the format of a bitstream in this embodiment. The bitstream is formed for respective subbands, which are arranged in turn from a subband having a low resolution in ascending order of resolution. Furthermore, in each subband, codes are set for respective bit planes, i.e., in the order from the upper to the lower bit planes. FIG. 9E shows the format of a bitstream in case of a color image made up of a luminance signal and color difference signals B-Y and R-Y. In this format, subbands are arranged in turn from a subband having a lower resolution of the luminance signal in ascending order of resolution for respective components. (SNR scalable)

FIGS. 10A to 10E show the format of a code sequence in which bit planes are arranged in turn from the MSB side (SNR scalable). FIG. 10A shows the entire format of a code sequence, in which MH is a main header; TH, a tile header; and BS, a bitstream. The main header MH is comprised of the size (the numbers of pixels in the horizontal and vertical directions) of an image to be encoded, a tile size upon breaking up the image into tiles as a plurality of rectangular regions, the number of components indicating the number of color components, the size of each component, and component information indicating bit precision, as shown in FIG. 10B. In this embodiment, since an image is not broken up into tiles, the tile size is equal to the image size, and when the image to be encoded is a monochrome multi-valued image, the number of components is “1”; when it is a color multi-valued image made up of R, G, and B component signals or a luminance and two color difference signals, the number of components is “3”.

FIG. 10C shows the format of the tile header TH. The tile header TH consists of a tile length including the bitstream length and header length of the tile of interest, an encoding parameter for the tile of interest, mask information indicating the designated region, and the bit shift amount for coefficients that belong to the designated region. The encoding parameter includes a discrete wavelet transform level, filter type, and the like. FIG. 10D shows the format of a bitstream in this embodiment. The bitstream is formed for respective bit planes, which are set in the order from the upper to the lower bit planes. In the bit planes, the encoding results of the bit planes of a given quantization index in each subband are sequentially set for respective subbands. In FIG. 10D, S is the number of bits required for expressing a maximum quantization index. FIG. 10E shows the format of a bitstream of a color image. Subbands of the luminance signal are arranged in turn from the upper to the lower bit planes, and the same applies to color difference signals R-Y and B-Y. The code sequence generated in this way is output to the code output unit 5.

In this embodiment, the compression ratio of the entire image to be encoded can be controlled by changing a quantization step Δ.

Also, in this embodiment, when lower bits of a bit plane to be encoded by the entropy encoder 4 are limited (discarded) in correspondence with a required compression ratio, not all bit planes are encoded, but bit planes from the most significant bit plane to a bit plane corresponding in number to the required compression ratio are encoded.

By exploiting a function of limiting lower bit planes, only bits corresponding to the designated region are included in large quantity in the code sequence, as shown in FIGS. 4A to 4C. That is, only the designated region is encoded at a low compression ratio, and can be compressed as a high-quality image.

(Decoding process)

A method of decoding a bitstream encoded by the aforementioned image processing apparatus will be explained below. FIG. 11 is a block diagram showing the arrangement of an image decoding apparatus for decoding the bitstream. In FIG. 11, reference numeral 7 denotes a code input unit; 8, an entropy decoder; 9, a dequantizer; 10, an inverse discrete wavelet transformer; and 11, an image output unit.

The code input unit 7 receives a code sequence, analyzes the header included in that code sequence to extract parameters required for the subsequent processes, and controls the flow of processes if necessary or outputs required parameters to the subsequent processing units. The bitstreams included in the input code sequence are output to the entropy decoder 8.

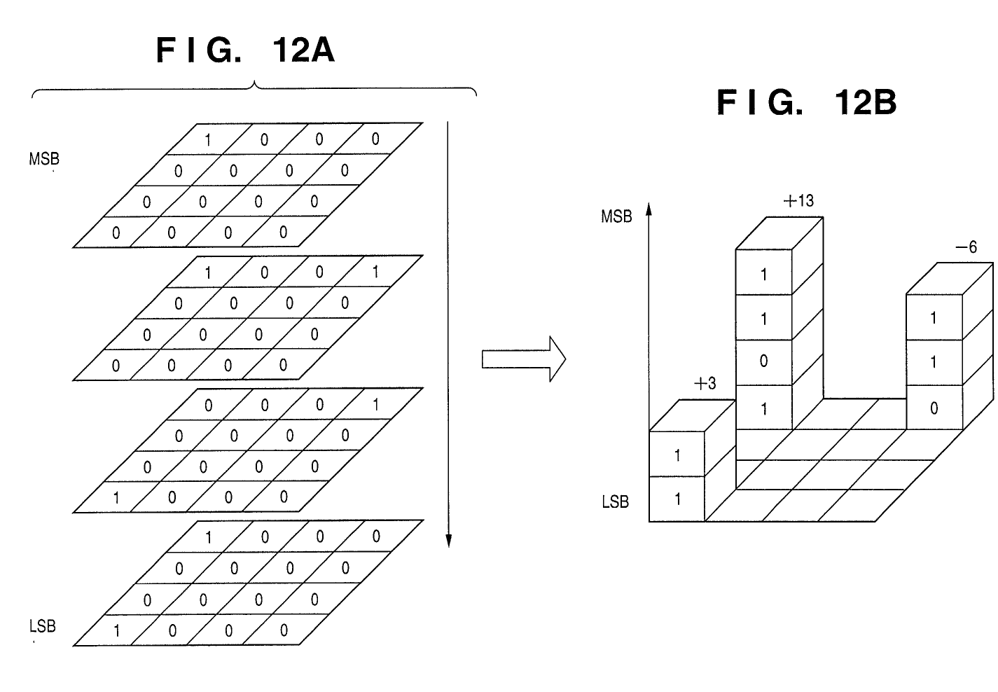

The entropy decoder 8 decodes and outputs the bitstreams for respective bit planes. FIGS. 12A and 12B show the decoding sequence at that time. FIG. 12A shows the process for sequentially decoding one subband region to be decoded for respective bit planes. Bit planes are decoded in the order of an arrow to finally restore quantization indices, as shown in FIG. 12B. The restored quantization indices are output to the dequantizer 9.

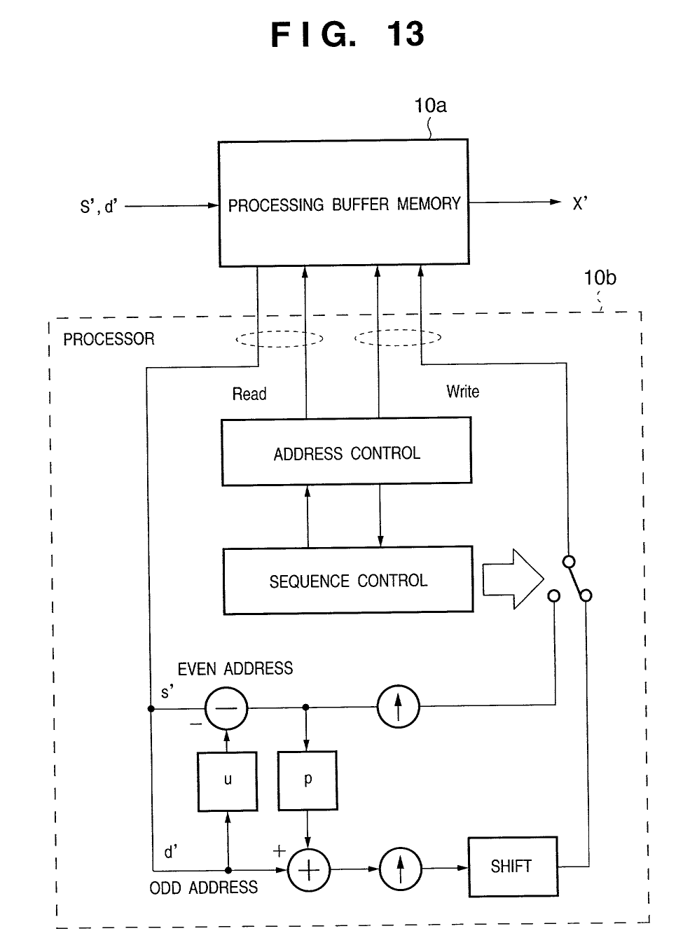

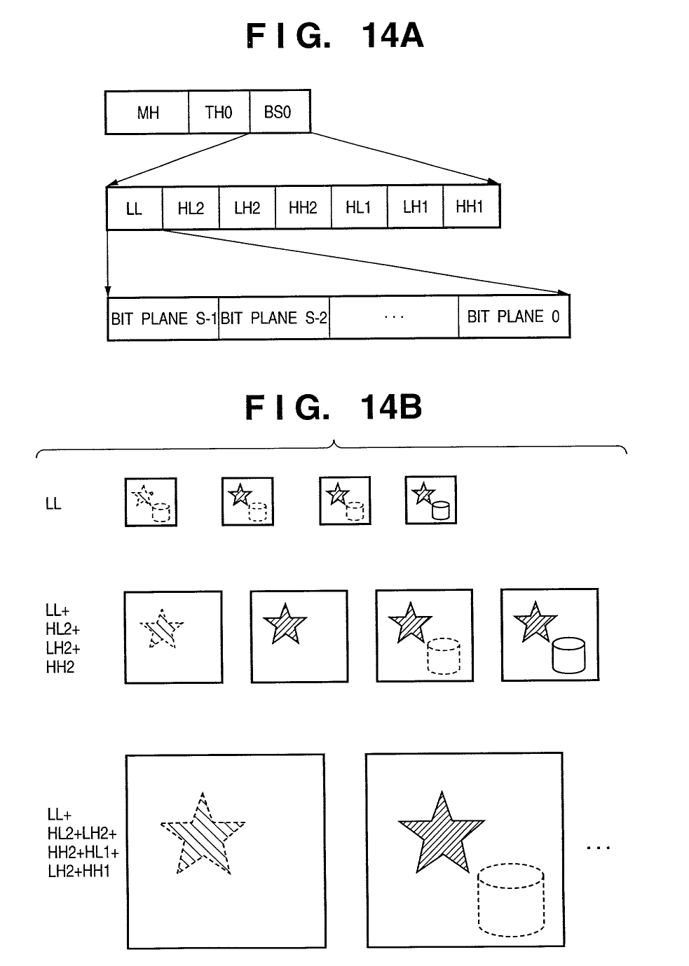

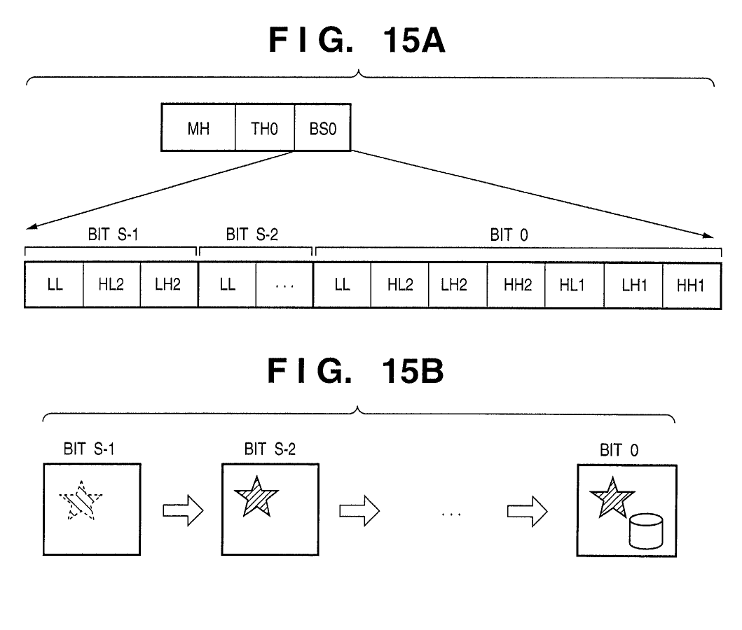

FIG. 13 is a block diagram showing the arrangement and process of the inverse discrete wavelet transformer 10.

Referring to FIG. 13, the input transform coefficients are stored in a processing buffer memory 10a. A processor 10b executes a linear inverse discrete wavelet transformation process while sequentially reading out the transform coefficients from the memory 10a, thus implementing a two-dimensional inverse discrete wavelet transformation process. The two-dimensional inverse discrete wavelet transformation process is executed in a sequence opposite to the forward transformation process, but since its details are known to those who are skilled in the art, a description thereof will be omitted. The dotted line portion in FIG. 13 includes processing blocks of the processor 10b. The input transform coefficients undergo two filter processes of filters u and p, and are added after being up-sampled, thus outputting an image signal x※. Note that the reconstructed image signal x※ substantially matches an original image signal x if all bit planes are decoded in bit plane decoding.

(Spatial scalable)

The image display pattern upon reclaiming and displaying an image having a code sequence in which bitstreams are arranged in turn from a subband having a low resolution in ascending order of resolution (spatial scalable), and are hierarchically output in the aforementioned sequence, will be explained using FIGS. 14A and 14B. FIG. 14A shows an example of a code sequence, the basic format of which is based on FIGS. 9A to 9D, but the entire image is set as a tile. Hence, the code sequence includes only one tile header THO and bitstream BSO.

In bitstream BSO, codes are arranged in turn from LL as a subband corresponding to the lowest resolution in ascending order of resolution, and are also arranged in each subband from the upper to the lower bit planes.

The image decoding apparatus shown in FIG. 11 sequentially reads this bitstream, and displays an image upon completion of decoding of codes of each bit plane. FIG. 14B shows the respective subbands, the sizes of images to be displayed in correspondence with the subbands, and changes in image upon decoding a code sequence in each subband. In FIG. 14B, a code sequence corresponding to LL is sequentially read out, and the image quality gradually improves along with the progress of the decoding processes of the respective bit planes. At this time, the star-shaped portion used as the designated region upon encoding is restored with higher image quality than other portions.

This is because the quantizer 3 shifts up the quantization indices which belong to the designated region upon encoding, and these quantization indices are decoded at earlier timings than other portions upon bit plane decoding. The same applies to other resolutions, i.e., the designated region portion is decoded with higher image quality.

Note that the designated region portion and other portions have equal image quality upon completion of decoding of all the bit planes. However, when decoding is interrupted in the middle of the processes, or when lower bit plane data is discarded, an image with the designated region portion restored to have higher image quality than other regions can be obtained.

(SNR scalable)

The image display pattern upon restoring and displaying an image signal with the code sequence format in which bit planes are arranged in the order from the MSB (SNR scalable) will be explained below using FIGS. 15A and 15B. FIG. 15A shows an example of a code sequence, the basic format of which is based on FIGS. 10A to 10D, but the entire image is set as a tile in this case. Hence, the code sequence includes only one tile header THO and bitstream BSO. In bitstream BSO, codes are arranged in turn from the most significant bit plane toward lower bit planes, as shown in FIG. 15A.

The image decoding apparatus shown in FIG. 11 sequentially reads this bitstream, and displays an image upon completion of decoding of codes of each bit plane. In FIG. 15B, the image quality gradually improves along with the progress of the decoding processes of the respective bit planes, and the star-shaped portion used as the designated region upon encoding is restored with higher image quality than other portions.

This is because the quantizer 3 shifts up the quantization indices which belong to the designated region upon encoding, and these quantization indices are decoded at earlier timings than other portions upon bit plane decoding.

Furthermore, the designated region portion and other portions have equal image quality upon completion of decoding of all the bit planes. However, when decoding is interrupted in the middle of the processes, or when lower bit plane data is discarded, an image with the designated region portion restored to have higher image quality than other regions can be obtained.

In the aforementioned embodiment, when the entropy decoder 8 limits (ignores) lower bit planes to be decoded, the encoded data to be received or processed is reduced, and the compression ratio can be consequently controlled. In this manner, a decoded image with required image quality can be obtained from only encoded data of the required data volume. When the quantization step Δ upon encoding is “1”, and all bit planes are decoded upon decoding, the reconstructed image is identical to the original image, i.e., reversible encoding and decoding can be implemented.

With the aforementioned process, an image is reclaimed and is output to the image output unit 11. The image output unit may be either an image display device such as a monitor or the like, or a storage device such as a magnetic disk or the like.

Note that the above embodiment adopts a scheme based on discrete wavelet transformation upon encoding an image, but may adopt other schemes.

<Application to Video Camera>

A video camera to which the aforementioned image processing apparatus is applied will be explained below.

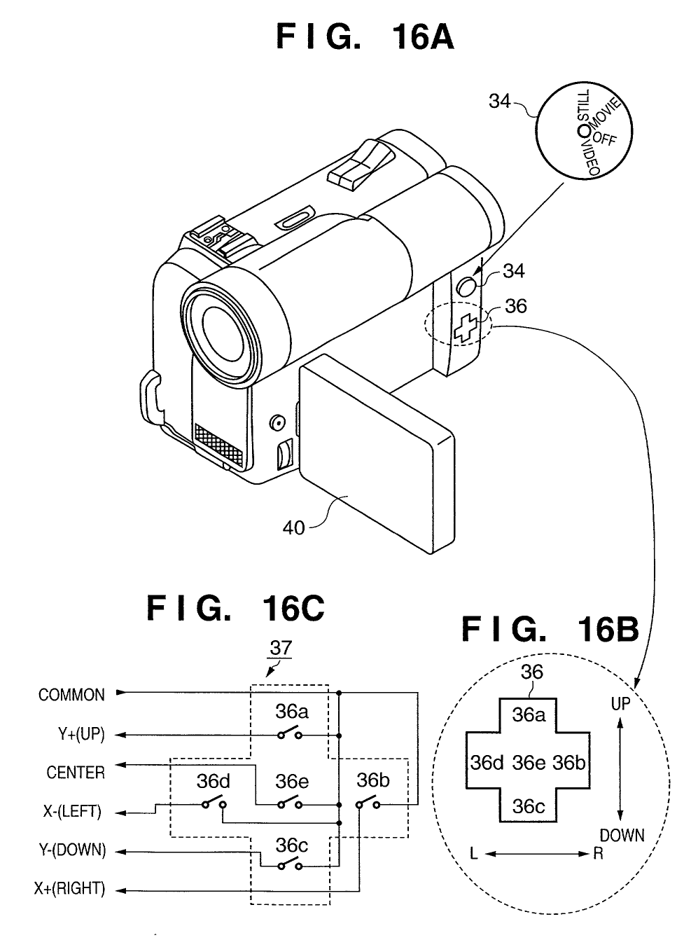

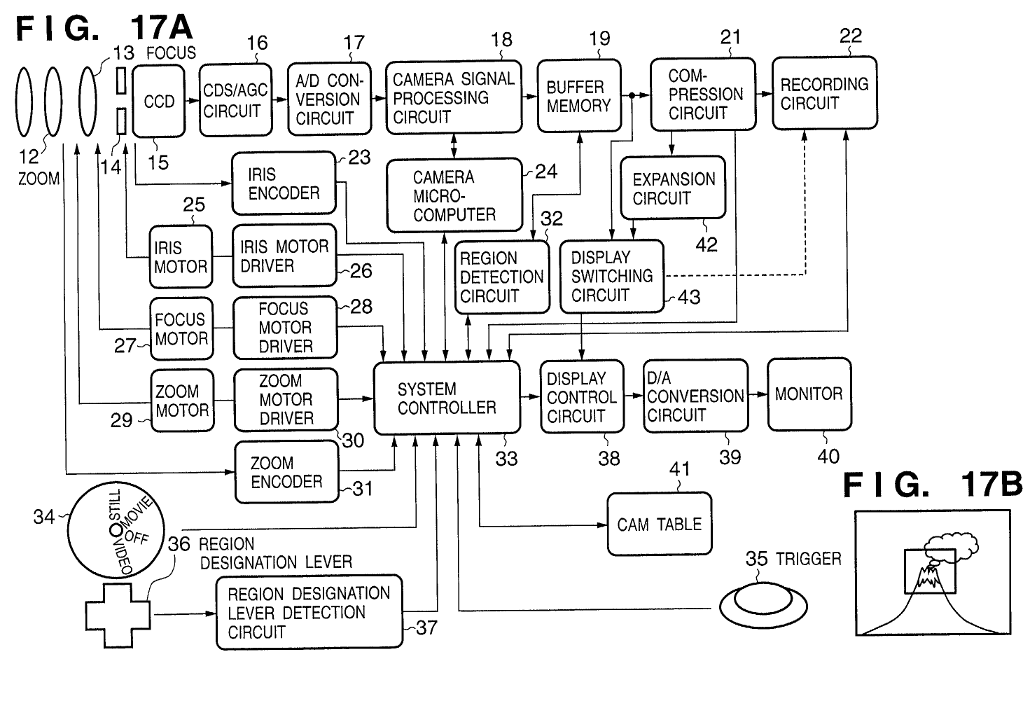

FIG. 16A shows the outer appearance of a video camera according to an embodiment of the present invention. FIG. 17A is a block diagram of a video camera according to the first embodiment of the present invention, and FIG. 17B shows a display example on a monitor 40. Note that this video camera is a digital camera that can sense a moving image and/or a still image.

A buffer memory 19 stores image data. A mode select dial 34 is used to select an operation mode from a moving image (MOVIE) mode/still image (STILL) mode/reproduction (VIDEO) mode/power OFF (OFF) mode. A trigger button 35 is used to start/stop image sensing. A region designation lever 36 is used to designate a given region on the display screen of the monitor 40, and a region designation lever detection circuit 37 detects the depression state of the region designation lever 36. The buffer memory 19 also stores region information. A display control circuit 38 generates an image indicating the designated region on the basis of the region information, and generates a display signal by superposing that image on a sensed image. A compression circuit 21 encodes the designated region and a non-designated region of image data using different processes on the basis of the region information. An expansion circuit 42 decodes and expands the image data encoded and compressed by the compression circuit 21.

Light coming from an object is zoomed by the zoom lens 12, and the zoomed light is focused by a focus lens 13. The amount of focused light is adjusted by an iris 14 to correct an exposure level, and that adjusted light is photoelectrically converted by a CCD 15. Image data output from the CCD 15 is sampled by a CDS/AGC circuit 16 to be adjusted to a predetermined gain, and is converted into a digital signal by an A/D conversion circuit 17. The converted digital image data is sent to a camera signal processing circuit 18, and undergoes image quality adjustment by a camera microcomputer 24. The image data that has undergone the image quality adjustment is stored in the buffer memory 19.

The display control circuit 38 generates display data on the basis of the image data stored in the buffer memory 19. The generated data is converted into an analog signal by a D/A conversion circuit 39, and that image is displayed on the monitor 40 which comprises a display such as an LCD or the like.

When a recording instruction of image data is input upon depression of the trigger button 35, data of R, G, and B color signals or a luminance signal and color difference signals of the image data stored in the buffer memory 19 are encoded by the compression circuit 21. The compressed image data is recorded by a recording circuit 22 which comprises a magnetic recording medium, a semiconductor memory, or the like.

When the user wants to set a portion of an image displayed on the monitor 40 to have high image quality, he or she designates a region to have high image quality on the image displayed on the monitor 40 using the region designation lever 36. A region detection circuit 32 generates region information of the designated region, and stores the generated region information in the buffer memory 19. The image data and region information stored in the buffer memory 19 are sent to the display control circuit 38, which generates display data by superposing a frame indicating the designated region on the sensed image. The display data is converted into an analog signal by the D/A converter 39, and that image is displayed on the monitor 40.

FIG. 17B shows a display example on the monitor 40. FIG. 17B shows an example of a display image after the high image quality region is designated by the region designation lever 36, and the designated region is displayed to be distinguished from a non-designated region.

On the other hand, when a recording instruction of image data is issued upon depression of the trigger button 35, the image data and region information stored in the buffer memory 19 are sent to the compression circuit 21. The image data is compressed by an encoding process which is separately done for a portion to be compressed with high image quality, and a portion to be normally compressed. The compressed image data is recorded by the recording circuit 22. Note that the data compressed by the compression circuit 21 is expanded by decoding in the expansion circuit 42, and a display switching circuit 43 switches a display signal, thus displaying the compressed image on the monitor 40.

The operation of the compression circuit 21 will be described in detail below using FIG. 19.

A wavelet transformation circuit 51 decomposes input image data into subbands. An occupation ratio computation circuit 52 generates mask information indicating coefficients of each decomposed subband, which belong to the designated region, and computes the occupation ratio of mask information. A bit shift amount computation circuit 53 computes the bit shift amount of an image signal in the mask information. A quantization processing circuit 54 performs quantization, and a coefficient setting circuit 59 sets compression parameters and quantization coefficients. An index change circuit 55 changes quantization indices in accordance with the bit shift amount. A bit plane decomposing circuit 56 decomposes quantization indices into bit planes, a coding control circuit 57 limits bit planes to be encoded, and a binary arithmetic coding circuit 58 executes an arithmetic coding process.

Respective components of image data, which is stored in the buffer memory 19 and is comprised of R, G, and B color signals or a luminance signal and color difference signals, are segmented into subbands. The segmented subband data are processed by the occupation ratio computation circuit 52, which generates mask information, and computes the occupation ratio of mask information in each subband.

The bit shift amount computation circuit 53 acquires parameters that designate the image quality of the designated region from the coefficient setting circuit 59. These parameters may be either numerical values that express a compression ratio to be assigned to the designated region or those indicating image quality. The bit shift amount computation circuit 53 computes the bit shift amount of coefficients in the designated region using the parameters, and outputs the bit shift amount to the quantization processing circuit 54 together with the mask information.

The quantization processing circuit 54 quantizes coefficients by dividing them by appropriate numerical values generated by the coefficient setting circuit 59, and outputs quantization indices corresponding to the quantized values.

The index change circuit 55 shifts only quantization indices which belong to the designated spatial region to the MSB side. The quantization indices changed in this way are output to the bit plane decomposing circuit 56. The bit plane decomposing circuit 56 decomposes the input quantization indices into bit planes. The coding control circuit 57 computes bit planes to determine the data size of the entire frame after compression, thus limiting bit planes to be encoded. The binary arithmetic coding circuit 58 executes binary arithmetic coding of bit planes in turn from the most significant bit plane, and outputs the coding result as a bitstream. The bitstream is output up to the limited bit plane.

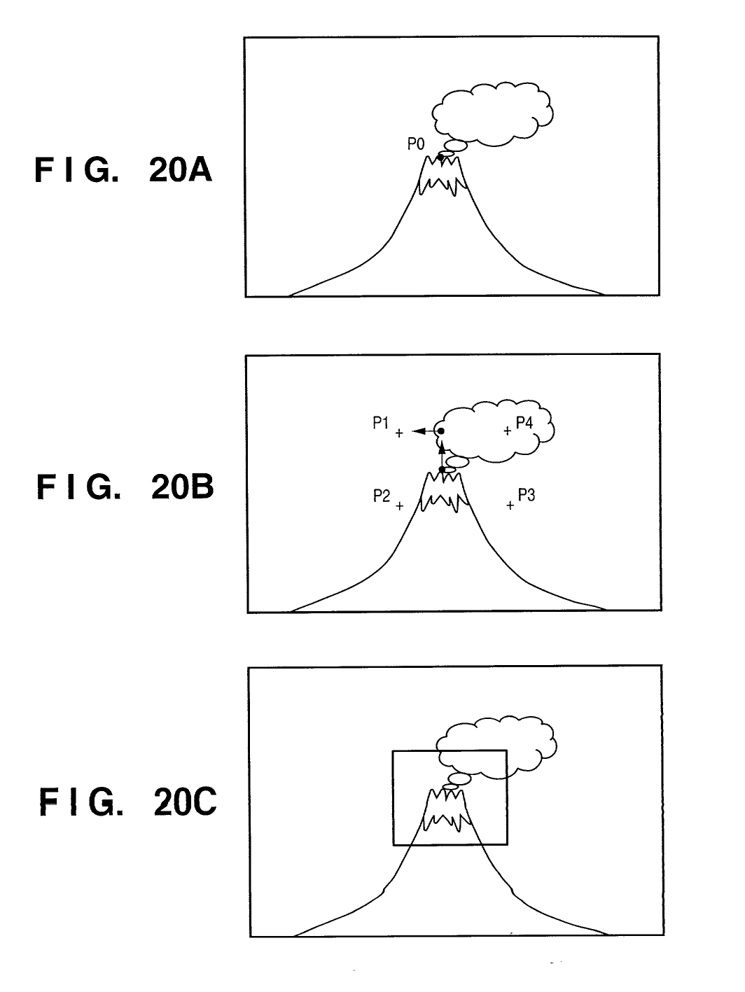

The sequence for designating the high image quality region will be explained using FIGS. 16B, 16C, and 20. FIG. 16B shows details of the region designation lever 36, FIG. 16B shows details of the region designation lever detection circuit 37, and FIG. 20 shows an example of an image displayed on the monitor 40.

Referring to FIG. 16B, the region designation lever 36 comprises an upward designation lever 36a for giving an instruction for moving a cursor upward, a rightward designation lever 36b for giving an instruction for moving the cursor rightward, a downward designation lever 36c for giving an instruction for moving the cursor downward, a leftward designation lever 36d for giving an instruction for moving the cursor leftward, and a select button 36e for giving an instruction for determining the cursor position.

Referring to FIG. 16C, an upward detection switch Y+ sends an upward cursor movement instruction to a system controller 33 upon receiving the instruction from the upward designation lever 36a, and a rightward detection switch X+ similarly sends a rightward cursor movement instruction to the system controller 33 upon receiving the instruction from the rightward designation lever 36b. A downward detection switch Y− sends a downward cursor movement instruction to the system controller 33 upon receiving the instruction from the downward designation lever 36c, and a leftward detection switch X− sends a leftward cursor movement instruction to the system controller 33 upon receiving the instruction from the leftward designation lever 36d. A select switch C sends a cursor determination instruction to the system controller 33 upon receiving the instruction from the select button 36e. A region can be designated by operating the levers (36a, 36b, 36c, and 36d), and the select button 36e of the region designation lever 36.

A method of designating a high image quality region using the region designation lever 36 while sensing a moving image will be explained below. Upon sensing a moving image, when the mode select dial 34 is set to select the moving image mode, the video camera is set in an image data recording standby state, and starts recording of a moving image upon depression of the trigger button 35. The monitor 40 displays a sensed moving image in either the recording standby or recording state. Such display can be done when the system controller 33 updates the contents of the buffer memory, e.g., every 1/30 sec, and supplies that output to the display control circuit 38 while switching the display signal by the switching circuit 43.

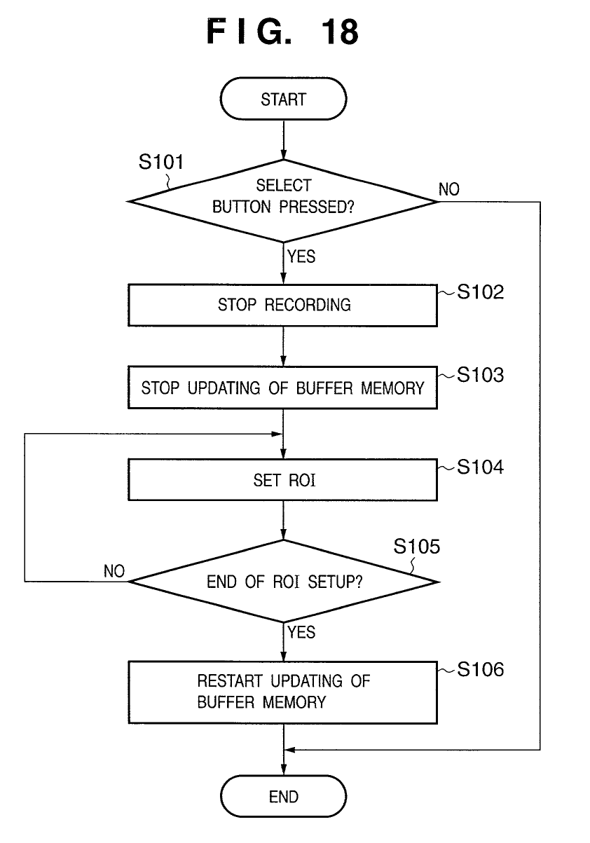

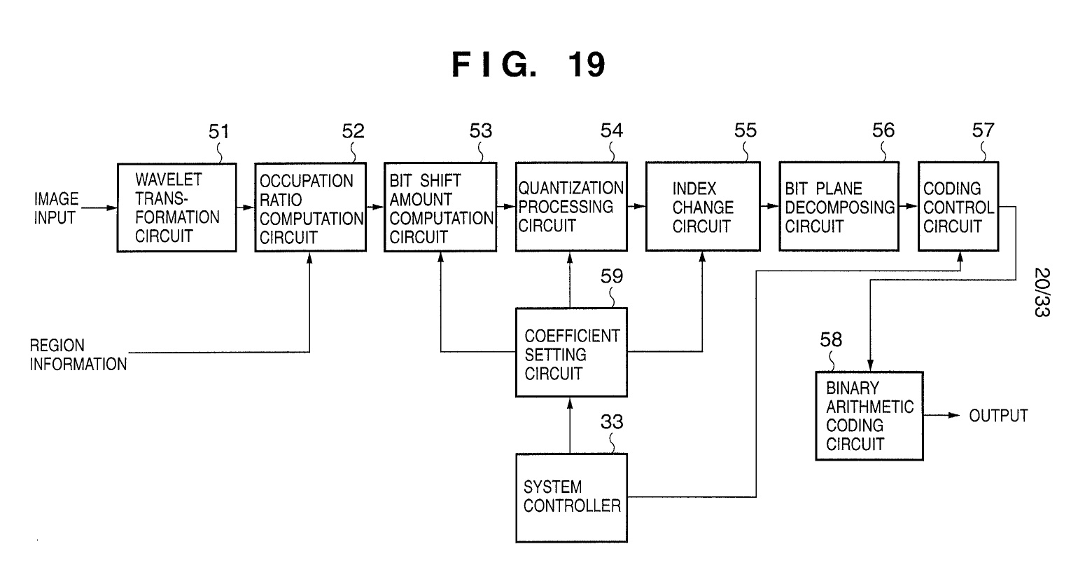

A case will be explained below using the flow chart in FIG. 18, wherein a given region of the sensed image is designated as a high image quality region. The user presses the select button 36e of the region designation lever 36 when a scene for which he or she wants to designate a region is displayed on the monitor 40. The system controller 33 detects depression of the select button (step S101), sets the recording standby state (step S102), and stops updating of the buffer memory 19 (step S103).

At this time, the monitor 40 displays a still image at an instance when the user has pressed the select button 36e, and a cursor P0 that can be used to designate a region is superimposed at the center of the monitor 40 (FIG. 20A). Since the still image is displayed, the user can easily set the designated region.

In step S104, the user operates the region designation lever 36 in a direction he or she wants to move the cursor P0 in the designated region setting mode, while observing the cursor P0 displayed on the monitor 40. The system controller 33 detects the depression state of the region designation lever 36, calculates the moving amount of the cursor based on the detection result, and moves the cursor P0 to the calculated position.

When the user presses the select button 36e of the region designation lever 36, one point of a frame that forms the high image quality region is determined. Likewise, the user moves the cursor by operating the region designation lever to determine the next point, and selects four points by repeating this operation (FIG. 20B).

When the user presses the select button 36e again, a region defined by points P1, P2, P3, and P4 is designated as a high image quality region (FIG. 20C). At the same time, the control leaves the designated region setting mode in step S105, and restarts updating of the buffer memory 19 in step S106, thus re-displaying a moving image on the monitor 40.

When the user presses the trigger button 35 in this state, moving image recording starts with designated the high image quality region, and in the subsequent image sensing process, an image contained in the designated region is encoded to be decodable with high image quality by the aforementioned sequence. When the user presses the trigger button 35 after he or she switches the mode select dial 34 to the still image mode, a still image can be recorded.

The color or luminance of the designated region may be changed to allow the user to confirm differences from other region at a glance. In this embodiment, the high image quality region is designated by selecting four points, but other arbitrary shapes such as a circle, polygon, and the like may be used.

In this embodiment, a portion of the display screen is set as the designated region. Since the designated region is a fixed region on the display screen, an object to be included in the designated region inevitably changes if the image sensing range has changed (e.g., when the camera angle has changed). However, it is often preferable to always record a specific object in the display screen, e.g., a person, object, or the like with high image quality irrespective of a change in image sensing range.

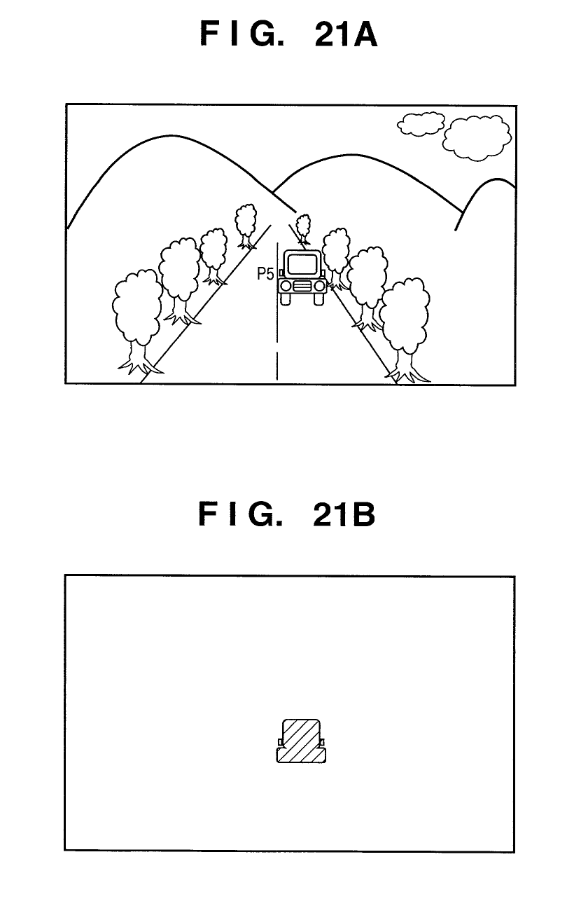

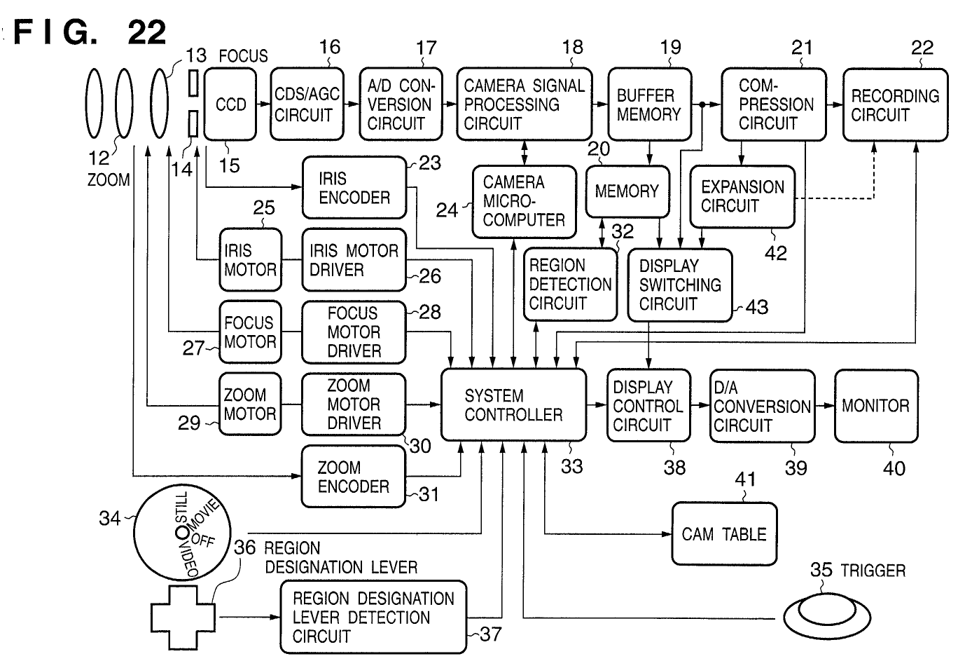

Hence, a specific object or person may be designated using, e.g., edge components or color components by a known image process, especially, an image recognition process, and may be set as the designated region. FIG. 21A shows the display state on the monitor. For example, when the user wants to record an automobile in FIG. 21A with high image quality, he or she adjusts the cursor to the automobile by operating the region designation lever 36 and presses the select switch 36e. Then, the region detection circuit 32 can extract an object image using, e.g., color and edge components by a known image recognition technique. FIG. 21B shows the extracted object image. In this case, the object image is recognized as the aforementioned designated region. Note that the object may be designated using motion information in place of the aforementioned method. Also, as a method of designating a high image quality region more precisely, a touch panel may be used for the monitor 40 in place of or in combination with the region designation lever 36.

In the above embodiment, the operation when the mode select dial 34 is set at the moving image mode has been explained. When the mode select dial 34 is set at the still image mode, substantially the same operation is done except that recording need not be paused in step S102 in FIG. 18.

<Second Embodiment>

In the video camera of the first embodiment, recording is temporarily paused when a region is designated during moving image recording. In the second embodiment, a region can be designated without pausing recording. Only differences from the block diagram in FIG. 17A will be explained using FIG. 22.

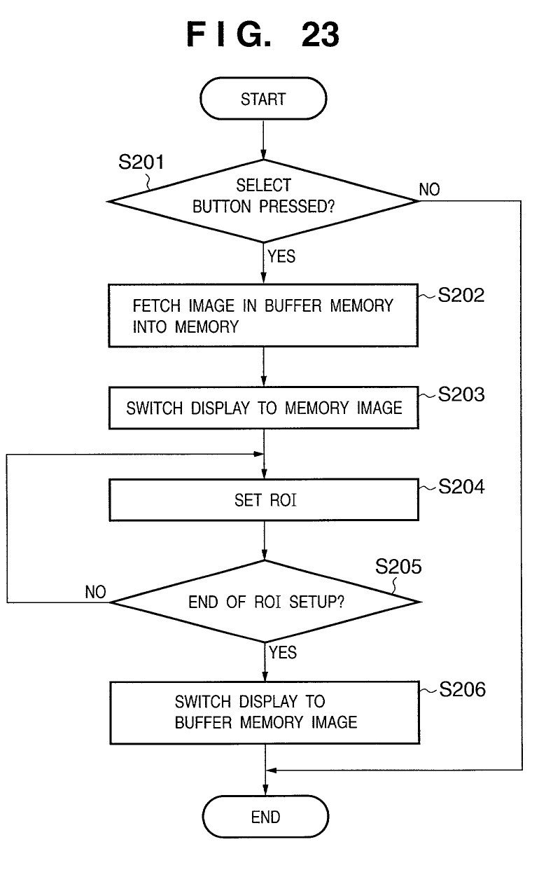

Referring to FIG. 22, a memory 22 can store data for one frame sent from the buffer memory. The operation using this memory 20 will be explained below using the flow chart shown in FIG. 23.

The user presses the select button 36e of the region designation lever 36 when a scene for which he or she wants to designate a region is displayed on the monitor 40. The system controller 33 detects depression of the select button (step S201), captures the image in the buffer memory 19 to the memory 20, and sends the image in the memory 20 to the monitor 40 by controlling the display switching circuit 43 (step S203). After that, the designated region is set in step S204 as in the first embodiment. In this case, the region detection circuit 32 detects a region based on the image in the memory 20. When the control leaves the setting mode in step S205, the display switching circuit 43 is controlled again in step S206 to send the image in the buffer memory 19 to the monitor 40.

During region setting, since the output from the buffer memory 19 is kept supplied to the compression circuit 21, image data recording is never interrupted.

<Third Embodiment>

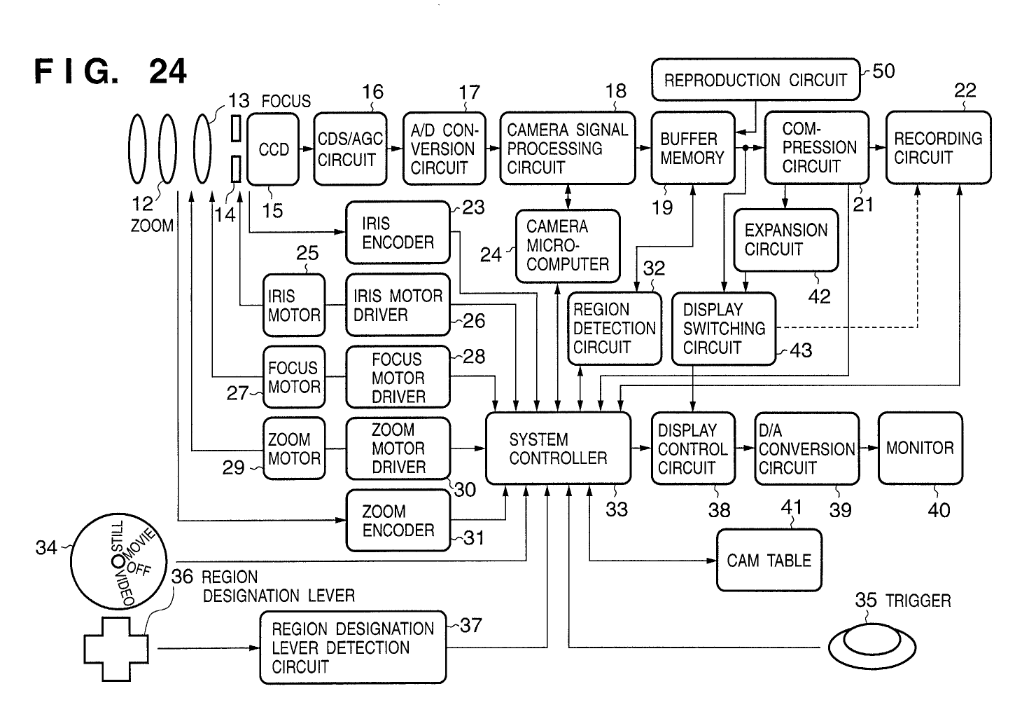

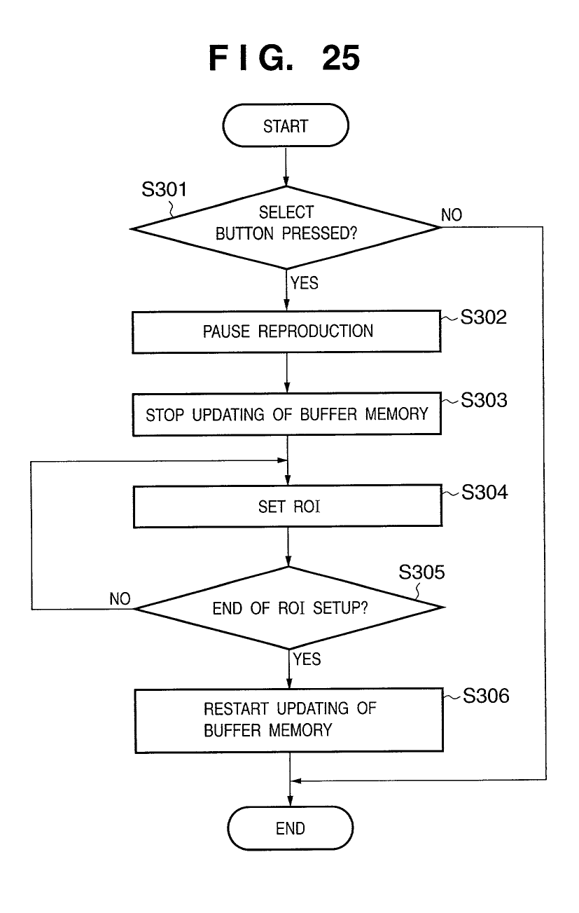

In the video camera of the first embodiment, an image obtained upon image sensing has been explained. Alternatively, a high image quality region can be set even for an image obtained by reproducing image data recorded on a recording medium such as a video tape previously, and that image can be re-recorded. Only differences from the block diagram in FIG. 17A will be explained using FIGS. 24 and 25.

Referring to FIG. 24, a reproduction unit 50 reads and reproduces image data from a recording medium (not shown). When the user selects the reproduction mode (VIDEO) using the mode select dial 34, the buffer memory 19 receives a reproduction signal from the reproduction unit 50 in place of a signal from the camera signal processing circuit 18.

The process of this embodiment will be explained below using the flow chart in FIG. 25. The user presses the select button 36e of the region designation lever 36 when a scene for which he or she wants to designate a region is displayed on the monitor 40. The system controller 33 detects depression of the select button (step S301), pauses reproduction (step S302), and stops updating of the buffer memory 19 (step S303). At this time, a still image at the instance when the user has pressed the select button 36e is displayed on the monitor 40, and the cursor P0 that can be used to designate a region is superimposed at the center of the monitor 40 (FIG. 20A). In step S304, the user operates the region designation lever 36 in a direction he or she wants to move the cursor P0 in the designated region setting mode, while observing the cursor P0 displayed on the monitor 40. The system controller 33 detects the depression state of the region designation lever 36, calculates the moving amount of the cursor based on the detection result, and moves the cursor P0 to the calculated position. When the user presses the select button 36e of the region designation lever 36, one point of a frame that forms the high image quality region is determined. Likewise, the user moves the cursor by operating the region designation lever to determine the next point, and selects four points by repeating this operation (FIG. 20B).

When the user presses the select button 36e again, a region defined by points P1, P2, P3, and P4 is designated as a high image quality region (FIG. 20C). At the same time, the control leaves the designated region setting mode in step S305, and restarts updating of the buffer memory 19 in step S306, thus re-displaying a reproduced image on the monitor 40. When the user presses the trigger button 35 in this state, image data of a reproduced image can be recorded by the recording circuit 22 with the high image quality region being designated.

<Fourth Embodiment>

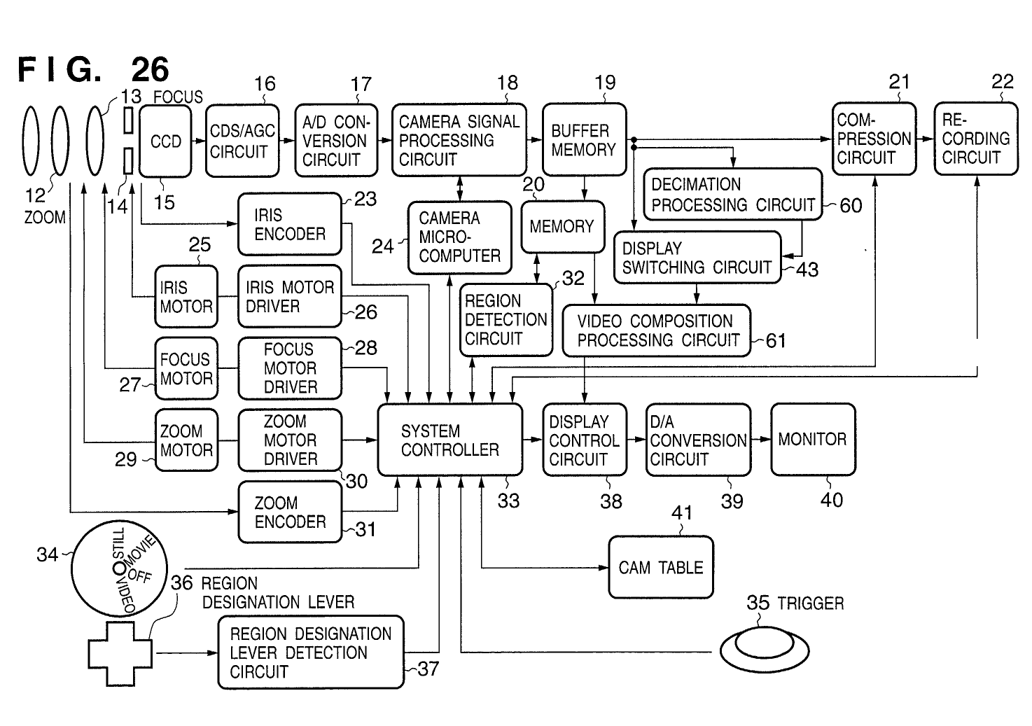

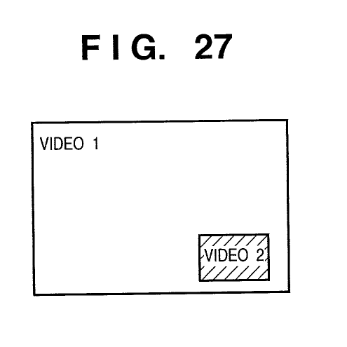

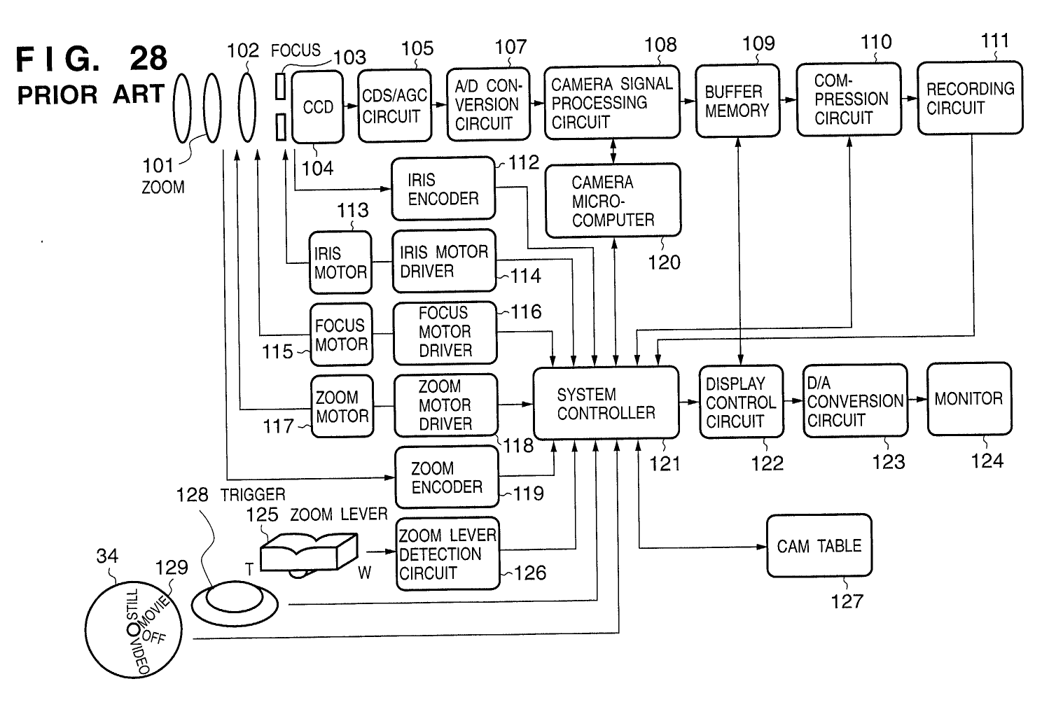

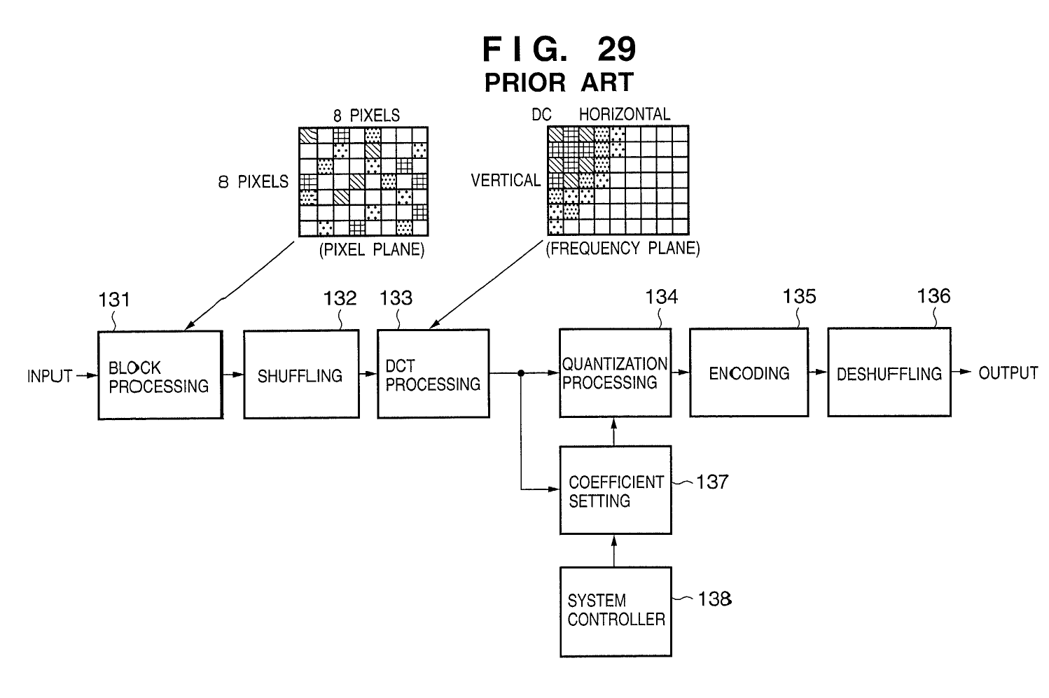

In the video camera of the first embodiment, since a still image is displayed on the monitor during region designation, the user cannot review a video to be actually recorded on the monitor. In this embodiment, while a moving image is recorded, the user can review it on the monitor even during region designation using a still image. FIG. 26 is a block diagram showing the arrangement of this embodiment, and FIG. 27 shows an example of a video on the monitor. Only differences from the block diagram of FIG. 17A will be explained below.

Referring to FIG. 26, image data from the buffer memory 19 is also sent to a decimation processing circuit 60. The decimation processing circuit 60 decimates image data in accordance with a decimation ratio designated by the system controller 33, and outputs the decimated image data to the switching circuit 43.

A video composition processing circuit 61 composites image data from the memory 20 and the decimated image data, converts the composite image data into an analog video signal, and outputs the analog video signal to the display control circuit 38.

In the above arrangement, a video in the buffer memory 19 is fetched to the memory 20 during region designation. On the other hand, the system controller 33 switches the switching circuit 43 to input image data from the decimation processing circuit 60, thus outputting a decimated moving image to the video composition processing circuit 61. As shown in FIG. 27, he video composition processing circuit 61 processes to display a still image from the memory 20 as video 1, and a moving image from the switching circuit 43 as video 2, and outputs the processed image to the monitor 40 via the display control circuit 38.

When the designated region overlaps video 2, the video composition processing circuit 61 may be controlled to move video 2 to another location.

<Fifth Embodiment>

In the second embodiment, an image is always recorded, and if a designated region is set, an image in the designated region can be encoded to be decodable with higher image quality than an image in the non-designated region. However, it is difficult to instantaneously set a designated region, and a predetermined time period is required from the beginning (start operation of the region designation lever 36) to the end (end operation of the region designation lever 36) of designation. Therefore, an important scene cannot often be encoded to be decodable with high image quality. To solve this problem, in this embodiment, sensed image data is temporarily stored, and image data from the beginning to the end of designation of the designated region is re-compressed (re-encoded) later.

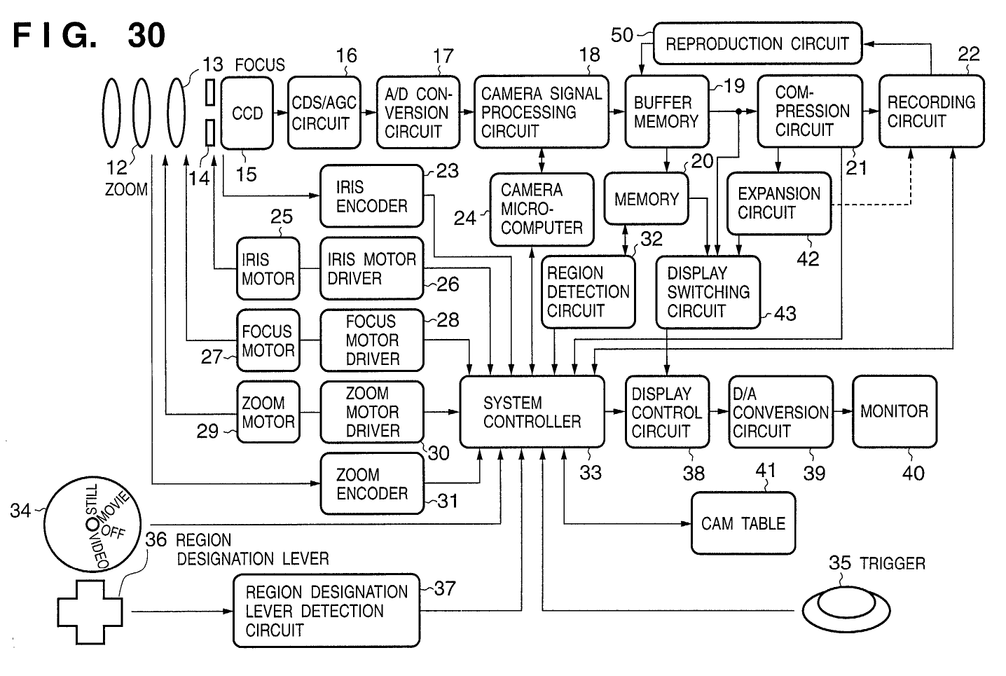

FIG. 30 is a block diagram of a video camera according to the fifth embodiment of the present invention. Only differences from the block diagram in FIG. 22 will be explained. Referring to FIG. 30, a reproduction circuit 50 reads out and decodes compressed image data recorded in the recording circuit 22, and stores the decoded data in the buffer memory.

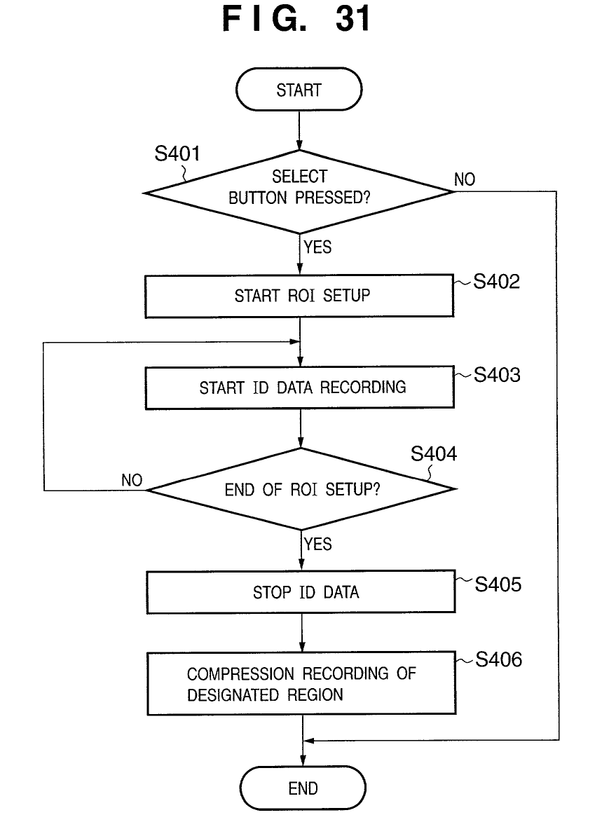

The process upon setting the designated region in this embodiment will be explained below using the flow chart in FIG. 31.

The user presses the select button 36e of the region designation lever 36 while observing the monitor 40, so as to designate a region during moving image recording. The system controller 33 detects depression of the select button (step S401), and starts a region designation process (step S402).

At the same time, ID data is recorded in the recording circuit 22 in response to an instruction from the system controller 33 (step S403). Alternatively, the system controller 33 may directly write ID data in the recording circuit 22. This ID data indicates that image data recorded in the recording circuit 22 is data recorded from the beginning to the end of region designation. From the beginning to the end of region designation, the compression circuit 21 records image data in the recording circuit 22 without compressing it, or compresses the entire image data to be decodable with high image quality and records that image data in the recording circuit 22.

Upon completion of setup of the designated region (depression of the select button 36e) (step S404), ID data recording is stopped (step S405). In step S406, image data is recorded in the recording circuit 22 via the compression circuit 21 by the aforementioned compression method while the designated region is set.

In the second embodiment, since the designated region is not settled during an interval from the instance when the user has pressed the select button 36e in step S401 until step S404 begins, image data is recorded via a normal process, e.g., as compressed image data for a region other than the designated region.

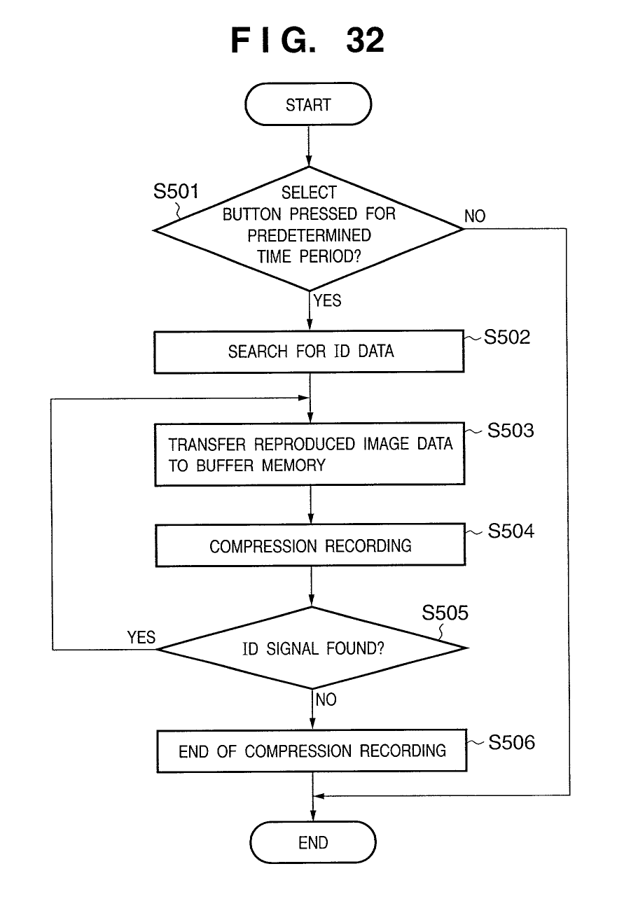

In the fifth embodiment, since ID data is appended to image data recorded in the recording circuit 22 from the beginning to the end of region designation, image data recorded in the recording circuit 22 is read out by the reproduction circuit 50 later (e.g., after image sensing), is re-compressed and re-recorded. This process will be described blow using the flow chart in FIG. 32.

When the user presses the select button 36e for a predetermined period of time or more (step S501) after image sensing is complete and image data recording is stopped, the reproduction circuit 50 searches the recording circuit 22 for the start point of ID data recorded previously (step S502). Such search process can be implemented by a known index search technique or the like. The reproduction circuit 50 reads out image data appended with ID data from the recording circuit 22, and sends the readout image data to the buffer memory 19 (step S503). In this case, if the readout image data has been compressed, the reproduction circuit 50 sends that data to the buffer memory 19 after it expands the data.

The compression circuit 21 reads out the image data sent from the reproduction circuit 50 to the buffer memory 19 from the buffer memory 19, re-compresses the readout data, and overwrites the re-compressed data on the recording circuit 22 (step S504). In this case, the compression circuit 21 re-compresses an image in a region corresponding to the designated region set previously to be decoded with high image quality.

In step S505, the reproduction circuit 50 searches for ID data again. If another ID data is found, the flow returns to step S503.

In this way, the aforementioned sequence is repeated until no ID data is detected. If the recording circuit 22 uses a magnetic disk, semiconductor memory, or the like, since it allows random access, the storage order of image data can be rearranged in a time-series order. Therefore, image data is consequently recorded from the start scene of region designation, so that the designated region is decodable with high image quality. If the designated region is known upon re-compression, only that region can be shifted up and encoded, thus facilitating re-compression.

In the fifth embodiment, the same region as that in the first recording is automatically designated and overwritten upon re-recording. Alternatively, after a still image is displayed, and the designated region is set again in step S502, re-compression and re-recording may be done.

The preferred embodiments of the present invention have been explained. The above embodiments can implement the aforementioned processes on a computer by software. That is, the objects of the present invention can be achieved by supplying a program code of software that can implement the above embodiments to a system or apparatus, and reading out and executing the program code by a computer (CPU or MPU) in the system or apparatus.

In this case, the program itself of software implements the functions of the above embodiments, and the program code itself, and that program, or a storage medium or program product which stores the program means constitutes the present invention. The functions of the above-mentioned embodiments may be implemented not only by executing the readout program code by the computer but also by some or all of actual processing operations executed by an OS (operating system) running on the computer on the basis of an instruction of the program code.

Furthermore, when the supplied program code is stored in a memory equipped on a function extension card of the computer or a function extension unit connected to the computer, a CPU or the like equipped on the function extension card or unit executes some or all of actual processes on the basis of the instruction of that program code, and the functions of the above embodiment are implemented by those processes, such case is also included in the scope of the present invention.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
display means for displaying a moving image on the basis of input image data;
designation means for designating a partial region in a display screen of said display means; and
encoding means for encoding the image data,
wherein said display means displays a still image of the moving image during designation by said designation means, and
said encoding means encodes the image data with an image included in the region designated by said designation means of the moving image displayed by said display means being decodable to have higher image quality than an image of a non-designated region.

2. An image processing apparatus comprising:
display means for displaying a moving image on the basis of input image data;
designation means for designating an object included in the moving image displayed by said display means; and
encoding means for encoding the image data,
wherein said display means displays a still image of the moving image during designation by said designation means, and
said encoding means encodes the image data with an image indicating the object designated by said designation means of the moving image displayed by said display means being decodable to have higher image quality than an image of a non-designated portion.

3. An image processing apparatus comprising:
display means for displaying a moving image on the basis of input image data;
designation means for designating a partial region in a display screen of said display means; and
encoding means for encoding the image data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image included in the region designated by said designation means of the moving image displayed by said display means by a predetermined number of bits.

4. An image processing apparatus comprising:
display means for displaying a moving image on the basis of input image data;
designation means for designating an object included in the moving image displayed by said display means; and
encoding means for encoding the image data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image indicating the object designated by said designation means of the moving image displayed by said display means by a predetermined number of bits.

5. The apparatus according to claim 1, wherein said display means simultaneously displays the moving image and the still image of the moving image during designation by said designation means.

6. The apparatus according to claim 2, wherein said display means simultaneously displays the moving image and the still image of the moving image during designation by said designation means.

7. The apparatus according to claim 3, wherein said display means simultaneously displays the moving image and the still image of the moving image during designation by said designation means.

8. The apparatus according to claim 4, wherein said display means simultaneously displays the moving image and the still image of the moving image during designation by said designation means.

9. The apparatus according to claim 1, further comprising means for saving the encoded data generated by said encoding means.

10. The apparatus according to claim 2, further comprising means for saving the encoded data generated by said encoding means.

11. The apparatus according to claim 3, further comprising means for saving the encoded data generated by said encoding means.

12. The apparatus according to claim 4, further comprising means for saving the encoded data generated by said encoding means.

13. The apparatus according to claim 1, further comprising image sensing means for generating the image data by sensing an image.

14. The apparatus according to claim 2, further comprising image sensing means for generating the image data by sensing an image.

15. The apparatus according to claim 3, further comprising image sensing means for generating the image data by sensing an image.

16. The apparatus according to claim 4, further comprising image sensing means for generating the image data by sensing an image.

17. The apparatus according to claim 1, wherein the image data is image data recorded in a recording medium.

18. The apparatus according to claim 2, wherein the image data is image data recorded in a recording medium.

19. The apparatus according to claim 3, wherein the image data is image data recorded in a recording medium.

20. The apparatus according to claim 4, wherein the image data is image data recorded in a recording medium.

21. A digital camera comprising:
image sensing means for generating image data by sensing an image;
display means for displaying a moving image on the basis of the image data;
designation means for designating a partial region in a display screen of said display means;
encoding means for encoding the image data; and
means for saving the encoded data,
wherein said display means displays a still image of the moving image during designation by said designation means, and
said encoding means encodes the image data with an image included in the region designated by said designation means of the moving image displayed by said display means being decodable to have higher image quality than an image of a non-designated region.

22. A digital camera comprising:
image sensing means for generating image data by sensing an image;
display means for displaying a moving image on the basis of the image data;
designation means for designating an object included in the moving image displayed by said display means;
encoding means for encoding the image data; and
means for saving the encoded data,
wherein said display means displays a still image of the moving image during designation by said designation means, and
said encoding means encodes the image data with an image indicating the object designated by said designation means of the moving image displayed by said display means being decodable to have higher image quality than an image of a non-designated portion.

23. A digital camera comprising:
image sensing means for generating image data by sensing an image;
display means for displaying a moving image on the basis of the image data;
designation means for designating a partial region in a display screen of said display means;
encoding means for encoding the image data; and
means for saving the encoded data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image included in the region designated by said designation means of the moving image displayed by said display means by a predetermined number of bits.

24. A digital camera comprising:
image sensing means for generating image data by sensing an image;
display means for displaying a moving image on the basis of the image data;
designation means for designating an object included in the moving image displayed by said display means;
encoding means for encoding the image data; and
means for saving the encoded data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image indicating the object designated by said designation means of the moving image displayed by said display means by a predetermined number of bits.

25. An image processing method comprising:
the display step of displaying a moving image on the basis of input image data;
the designation step of designating a partial region in a display screen in the display step; and
the encoding step of encoding the image data,
wherein the display step includes the step of displaying a still image of the moving image during designation in the designation step, and
the encoding step includes the step of encoding the image data with an image included in the region designated in the designation step of the moving image displayed in the display step being decodable to have higher image quality than an image of a non-designated region.

26. An image processing method comprising:
the display step of displaying a moving image on the basis of input image data;
the designation step of designating an object included in the moving image displayed in the display step; and
the encoding step of encoding the image data,
wherein the display step includes the step of displaying a still image of the moving image during designation in the designation step, and
the encoding step includes the step of encoding the image data with an image indicating the object designated in the designation step of the moving image displayed by the display step being decodable to have higher image quality than an image of a non-designated portion.

27. An image processing method comprising:
the display step of displaying a moving image on the basis of input image data;
the designation step of designating a partial region in a display screen in the display step; and
the encoding step of encoding the image data,
wherein the display step includes the step of displaying a still image of the moving image during designation in the designation step,
the encoding step comprises:
the step of generating transform coefficients by computing discrete wavelet transforms of the image data;
the step of generating quantization indices by quantizing the transform coefficients; and
the step of generating encoded data by decomposing the quantization indices into bit planes, and executing arithmetic coding for the respective bit planes, and
the encoding step includes the step of shifting up the quantization indices corresponding to an image included in the region designated in the designation step of the moving image displayed by the display step by a predetermined number of bits.

28. An image processing method comprising:
the display step of displaying a moving image on the basis of input image data;
the designation step of designating an object included in the moving image displayed in the display step; and
the encoding step of encoding the image data,
wherein the display step includes the step of displaying a still image of the moving image during designation in the designation step,
the encoding step comprises:
the step of generating transform coefficients by computing discrete wavelet transforms of the image data;
the step of generating quantization indices by quantizing the transform coefficients; and
the step of generating encoded data by decomposing the quantization indices into bit planes, and executing arithmetic coding for the respective bit planes, and
the encoding step includes the step of shifting up the quantization indices corresponding to an image indicating the object designated in the designation step of the moving image displayed by the display step by a predetermined number of bits.

29. A program for making a computer function as:
display means for displaying a moving image on the basis of input image data;
designation means for designating a partial region in a display screen of said display means; and
encoding means for encoding the image data,
wherein said display means displays a still image of the moving image during designation by said designation means, and
said encoding means encodes the image data with an image included in the region designated by said designation means of the moving image displayed by said display means being decodable to have higher image quality than an image of a non-designated region.

30. A program for making a computer function as:
display means for displaying a moving image on the basis of input image data;
designation means for designating an object included in the moving image displayed by said display means; and
encoding means for encoding the image data,
wherein said display means displays a still image of the moving image during designation by said designation means, and
said encoding means encodes the image data with an image indicating the object designated by said designation means of the moving image displayed by said display means being decodable to have higher image quality than an image of a non-designated portion.

31. A program for making a computer function as:
display means for displaying a moving image on the basis of input image data;
designation means for designating a partial region in a display screen of said display means; and
encoding means for encoding the image data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image included in the region designated by said designation means of the moving image displayed by said display means by a predetermined number of bits.

32. A program for making a computer function as:
display means for displaying a moving image on the basis of input image data;
designation means for designating an object included in the moving image displayed by said display means; and
encoding means for encoding the image data,
wherein said display means displays a still image of the moving image during designation by said designation means,
said encoding means comprises:
means for generating transform coefficients by computing discrete wavelet transforms of the image data;
means for generating quantization indices by quantizing the transform coefficients; and
means for generating encoded data by decomposing the quantization indices into bit planes, and executing arithmetic coding for the respective bit planes, and
said encoding means shifts up the quantization indices corresponding to an image indicating the object designated by said designation means of the moving image displayed by said display means by a predetermined number of bits.

33. An image processing apparatus comprising:
display means for displaying a moving image on the basis of input image data;
designation means for designating a partial region in a display screen of said display means;
encoding means for generating encoded data by encoding the image data;
storage means for storing the encoded data; and
decoding means for decoding the encoded data stored in said storage means,
wherein said display means displays a still image of the moving image during designation by said designation means,
said encoding means encodes the image data with an image included in the region designated by said designation means of the moving image displayed by said display means being decodable to have higher image quality than an image of a non-designated region,
said decoding means decodes encoded data at least from the beginning to the end of designation of the region by said designation means of the encoded data stored in said storage means, and
said encoding means re-encodes the decoded image data with an image corresponding to the region of an image that corresponds to the image data decoded by said decoding means being decodable to have higher image quality than an image of the non-designated region.

34. An image processing apparatus comprising:
display means for displaying a moving image on the basis of input image data;
designation means for designating an object included in the moving image displayed by said display means;
encoding means for generating encoded data by encoding the image data;
storage means for storing the encoded data; and
decoding means for decoding the encoded data stored in said storage means,
wherein said display means displays a still image of the moving image during designation by said designation means,
said encoding means encodes the image data with an image indicating the object designated by said designation means of the moving image displayed by said display means being decodable to have higher image quality than an image of a non-designated portion,
said decoding means decodes encoded data at least from the beginning to the end of designation of the object by said designation means of the encoded data stored in said storage means, and
said encoding means re-encodes the decoded image data with an image corresponding to the object of an image that corresponds to the image data decoded by said decoding means being decodable to have higher image quality than an image of the non-designated region.

35. An image processing method comprising:
the display step of displaying a moving image on the basis of input image data;
the designation step of designating a partial region in a display screen in the display step;
the encoding step of generating encoded data by encoding the image data;
the storage step of storing the encoded data; and
the decoding step of decoding the encoded data stored in the storage step,
wherein the display step includes the step of displaying a still image of the moving image during designation in the designation step,
the encoding step includes the step of encoding the image data with an image included in the region designated in the designation step of the moving image displayed in the display step being decodable to have higher image quality than an image of a non-designated region,
the decoding step includes the step of decoding encoded data at least from the beginning to the end of designation of the region in the designation step of the encoded data stored in the storage step, and
the encoding step includes the step of re-encoding the decoded image data with an image corresponding to the region of an image that corresponds to the image data decoded in the decoding step being decodable to have higher image quality than an image of the non-designated region.

36. An image processing method comprising:
the display step of displaying a moving image on the basis of input image data;
the designation step of designating an object included in the moving image displayed in the display step;
the encoding step of generating encoded data by encoding the image data;
the storage step of storing the encoded data; and
the decoding step of decoding the encoded data stored in the storage step,
wherein the display step includes the step of displaying a still image of the moving image during designation in the designation step,
the encoding step includes the step of encoding the image data with an image indicating the object designated in the designation step of the moving image displayed in the display step being decodable to have higher image quality than an image of a non-designated portion,
the decoding step includes the step of decoding encoded data at least from the beginning to the end of designation of the object in the designation step of the encoded data stored in the storage step, and
the encoding step includes the step of re-encoding the decoded image data with an image corresponding to the object of an image that corresponds to the image data decoded in the decoding step being decodable to have higher image quality than an image of the non-designated region.

37. A program for making a computer function as:
display means for displaying a moving image on the basis of input image data;
designation means for designating a partial region in a display screen of said display means;
encoding means for generating encoded data by encoding the image data; and
storage means for storing the encoded data; and
decoding means for decoding the encoded data stored in said storage means,
wherein said display means displays a still image of the moving image during designation by said designation means,
said encoding means encodes the image data with an image included in the region designated by said designation means of the moving image displayed by said display means being decodable to have higher image quality than an image of a non-designated region,
said decoding means decodes encoded data at least from the beginning to the end of designation of the region by said designation means of the encoded data stored in said storage means, and
said encoding means re-encodes the decoded image data with an image corresponding to the region of an image that corresponds to the image data decoded by said decoding means being decodable to have higher image quality than an image of the non-designated region.

38. A program for making a computer function as:
display means for displaying a moving image on the basis of input image data;
designation means for designating an object included in the moving image displayed by said display means;
encoding means for generating encoded data by encoding the image data;
storage means for storing the encode data; and
decoding means for decoding the encoded data stored in said storage means,
wherein said display means displays a still image of the moving image during designation by said designation means,
said encoding means encodes the image data with an image indicating the object designated by said designation means of the moving image displayed by said display means being decodable to have higher image quality than an image of a non-designated portion,
said decoding means decodes encoded data at least from the beginning to the end of designation of the object by said designation means of the encoded data stored in said storage means, and
said encoding means re-encodes the decoded image data with an image corresponding to the object of an image that corresponds to the image data decoded by said decoding means being decodable to have higher image quality than an image of the non-designated region.
